(19) United States
(12) Patent Application Publication
(10) Pub. No.: US 2026/0004647 A1
(43) Pub. Date: Jan. 1, 2026

(54) DISTRIBUTED MULTI-PARAMETER LINEAR FIRE DETECTOR

(71) Applicant: Linear-Detection, Inc., Cary, NC (US)

(72) Inventor: Wenbo YU, Cary, NC (US)

(73) Assignee: Linear-Detection, Inc., Cary, NC (US)

(21) Appl. No.: 19/251,750

(22) Filed: Jun. 26, 2025

Related U.S. Application Data
(63) Continuation of application No. 18/756,309, filed on Jun. 27, 2024.

(51) Int. Cl. G08B 17/10

(52) U.S. Cl. CPC G08B 17/10

(57) ABSTRACT

A distributed multi-parameter linear fire detector is configured to enhance fire safety in high-risk industrial environments, such as battery energy storage facilities. This system integrates a plurality of sensing modules, including volatile organic compounds (VOC), combustible gas, smoke, infrared, and linear heat sensors, to provide comprehensive, continuous monitoring of early fire indicators. An addressing module facilitates precise location identification, while an air sampling mechanism with multiple inlets offers real-time analysis. The central signal processing unit employs advanced algorithms to minimize false positives and accurately detect fire locations. This system ensures early detection and timely intervention, significantly reducing the risk of extensive damage and enhancing reliability in industrial applications.

### CROSS-REFERENCE TO RELATED APPLICATIONS

This is a continuation of U.S. patent application Ser. No. 18/756,309 filed on Jun. 27, 2024, the disclosure of which is hereby incorporated by reference in its entirety.

### BACKGROUND

Fire detectors are commonly deployed to monitor environmental conditions and identify indicators of fire hazards. Applications include detectors suitable for use in industrial environments, transportation systems, and manufacturing infrastructure, commercial and residential buildings. These detectors help ensure safety by providing early warnings and enabling prompt responses to potential fire incidents. These detectors may include sensors configured to respond to a specific fire-related parameter. Depending on the application, such detectors can be arranged to detect temperature changes, smoke particles, or other conditions associated with combustion or thermal events.

### SUMMARY

A linear fire detector is disclosed that includes a plurality of spatially distributed and heterogeneous sensors configured to detect fire-related parameters such as heat, smoke, and gases (e.g., volatile organic compounds). The sensors are constructed in a linear shape to achieve continuous fire anomaly detection. Fire hazard parameters are monitored at any point along the length of the detection cable. The sensors are operatively coupled, via wired or wireless connections, to a signal processor. The processor is configured to integrate signals from the sensors to generate a response function, with capabilities to provide continuous full coverage over a long distance, pinpoint fire hazard location, improves detection accuracy, reliability, specificity, or sensitivity through weighted signal fusion or contextual rule application.

In some embodiments, the detector includes a modular array of individually addressable sensing modules interconnected by linear cable segments incorporating air tubes. These sensing modules may include infrared and fiber-optic temperature sensors, total radiation pyrometers, smoke sensors, and gas sensors. The array may be deployed in planar or stacked configurations to form two-dimensional or three-dimensional sensor networks, allowing volumetric environmental monitoring and fire propagation tracking across multiple spatial layers. The processor can analyze this data to identify fire anomaly source presence, location, and spread patterns.

The detector further incorporates an artificial intelligence (AI) module configured to apply machine learning algorithms, such as neural networks, support vector machines, decision trees, or ensemble models to sensor data. The AI module facilitates fire event classification, predictive analytics, and adaptive algorithm selection based on contextual information. The system further supports online learning to enable continuous model updates based on real-time sensor feedback.

A user interface may also be included to present sensor outputs, prediction results, thermal maps, risk scores, or alert levels to facilitate human oversight and decision-making in safety-critical or environmentally monitored environments.

In an aspect, a sensing system is provided, including: a plurality of sensors spatially distributed; a processor configured to process signals from the plurality of sensors and couple the signals algorithmically to obtain a response function; wherein the plurality of sensors comprises at least two types of sensors.

In some embodiments, the signal processor is configured to integrate data from the plurality of sensors to selectively enhance at least one of accuracy, reliability, specificity, or sensitivity in the response function analysis.

In some embodiments, the plurality of sensors is configured to detect environmental changes and transmit data to the processor for analysis.

In some embodiments, the processor is configured to process the data to identify patterns, generate alerts, and optimize system performance.

In some embodiments, the sensing system further includes one or more cables coupling the plurality of sensors electrically.

In some embodiments, the plurality of sensors is coupled wirelessly.

In some embodiments, the processor is configured to assign different weights to different sensor outputs based on at least one of application scenarios, user preferences.

In some embodiments, the plurality of sensors comprises a two-dimensional array of heat-sensitive elements arranged across a plane.

In some embodiments, each heat-sensitive element in the two-dimensional array is individually addressable and configured to generate spatial heat distribution data corresponding to a monitored area.

In some embodiments, the processor is configured to analyze the spatial heat distribution data to determine the presence, location, and spread pattern of a heat source or fire event.

In some embodiments, the sensing system further includes a plurality of two-dimensional arrays of heat-sensitive elements stacked in multiple layers to form a three-dimensional sensor configuration.

In some embodiments, the processor is further configured to generate a three-dimensional thermal map based on data received from the stacked two-dimensional arrays.

In some embodiments, the thermal map provides volumetric heat distribution and is used to determine fire propagation across different spatial elevations within a monitored environment.

In some embodiments, the processor is further configured to predict the potential spread of the fire based on historical spatial propagation patterns and real-time sensor data.

In another aspect, a sensing system is provided, including: a plurality of heterogeneous sensors configured to detect environmental parameters; a processor operatively coupled to the plurality of sensors; and an artificial intelligence (AI) module configured to receive data from the plurality of sensors and apply at least one machine learning algorithm to process the data for event detection or prediction.

In some embodiments, the AI module is configured to classify sensor events based on learned patterns from historical sensor data.

In some embodiments, the AI module applies a neural network to correlate signals from different sensor types and generate a composite risk assessment output.

In some embodiments, the AI module is configured to dynamically select among different machine learning algorithms based on contextual parameters or performance metrics.

In some embodiments, the AI module includes at least one of: a support vector machine (SVM), decision tree, random forest, deep neural network (DNN), or ensemble learning model.

In some embodiments, the AI module is configured to update its prediction model using real-time sensor feedback through an online learning process.

In some embodiments, the sensing system further includes a user interface configured to display prediction results, risk scores, or alert levels generated by the AI module.

In another aspect, a distributed multi-parameter linear fire detector, is provided, including: a signal processing unit, a sensing module, and a composite air-tube cable; wherein the composite air-tube cable comprises a cable of a selected length comprising an air tube, a pair of insulated electrical conducting wires for power and data transmission, and a linear heat sensor; wherein the signal processing unit comprises a first housing, a fan, and a first circuit board; wherein the fan and the first circuit board are disposed within the first housing, and the first housing is provided with an exhaust hole; wherein the signal processing unit is configured to process signals from a plurality of sensors and couple the signals algorithmically to obtain a response function; wherein the sensing module comprises a second housing, sensing elements, and a second circuit board, wherein the sensing elements and the second circuit board are disposed within the second housing, the sensing element is electrically connected to the second circuit board, and the second housing is provided with an air inlet, wherein the air inlets are located at multiple places on the air-tube; wherein the composite air-tube cable is electrically connected to the second circuit board and communicates with the interior of the second housing, one end of the composite air-tube cable is provided with an end cap, and another end is electrically connected to the first circuit board and communicates with the interior of the first housing; wherein from the end cap, by activating the fan, fire characteristic substances are drawn from the air inlet of the sensing module into the second housing, wherein the sensing element is in communication electrically with the first circuit board, and the sensing element is configured to collect various information about fire characteristic substances.

In some embodiments, one sensing module includes at least two different types of sensing elements, wherein each sensing element comprises at least one of a particle sensor, a combustible gas sensor, a smoke sensor, a heat sensor, or a CO sensor.

In some embodiments, the signal processing unit further includes an alarm device, wherein the alarm device is in signal connection with the first circuit board, and the first circuit board is configured to determine whether the fire characteristic substances collected by the sensing elements trigger an alarm.

In some embodiments, multiple sensing modules are provided, and the second circuit boards of the multiple sensing modules are connected to the first circuit board via the composite air-tube cable.

In some embodiments, the sensing module further includes an address code, the address code is provided on the second circuit board, and the address code is configured to obtain the location where an alarm is triggered.

In some embodiments, the composite air-tube cable includes an air tube and a linear heat sensor, the linear heat sensor is configured to measure temperature and transmit signals to the first circuit board, and the air tube is configured for the transmission of fire characteristic substances.

In some embodiments, the second housing further includes a detection chamber inside, the composite air-tube cable connects with the detection chamber, and the detection chamber connects with the air inlet.

In some embodiments, both ends of the air tube connect with the detection chambers inside two adjacent second housings, or one end of the air tube is connected to the end cap and the other end connects with the detection chamber of the second housing, or one end of the air tube connects with the interior of the second housing and the other end connects with the interior of the first housing.

In some embodiments, the second housing further includes a filter inside, the filter is located at the air inlet, and the filter is configured to filter unwanted substances from fire characteristic substances.

In some embodiments, the signal processing unit and/or multiple sensing modules are selectively installed on the surface of the object to be measured or within the space to be measured.

In some embodiments, the processor is configured to process the data to identify patterns, generate alerts, and optimize system performance, and is further configured to: predict the potential spread of the fire based on historical spatial propagation patterns and real-time sensor data; assign weights to different sensing element output based on application scenarios and user preferences to obtain an overall score of the fire anomaly; or obtain overall probability of a fire by combining individual fire-related parameter probabilities derived from each sensing elements.

In some embodiments, the distributed multi-parameter linear fire detector further includes an artificial intelligence (AI) module configured to receive data from the plurality of sensors and apply at least one machine learning algorithm to process the data for event detection or prediction.

In some embodiments, the AI module is configured to classify sensor events based on learned patterns from historical sensor data.

In some embodiments, the AI module applies a supervised or unsupervised model including at least one of a neural network or an isolation forest to correlate signals from different sensor types and generate a composite risk assessment output.

In some embodiments, the AI module is configured to dynamically select among different machine learning algorithms based on contextual parameters or performance metrics.

In some embodiments, the AI module includes at least one of: a support vector machine (SVM), decision tree, random forest, deep neural network (DNN), or ensemble learning model.

In some embodiments, the AI module is configured to update its prediction model using real-time sensor feedback through an online learning process.

In some embodiments, the distributed multi-parameter linear fire detector further includes a user interface configured to display prediction results, risk scores, or alert levels generated by the AI module.

In some embodiments, the processor and the AI module are configured to implement a hybrid method combining the machine learning model and rule-based decision-making to determine whether to trigger fire alarm.

In some embodiments, the plurality of sensors comprise at least one type of sensing elements continuously distributed along the cable.

In some embodiments, the signal processor is configured to integrate data from the plurality of sensors to selectively enhance at least one of accuracy, reliability, specificity, sensitivity, or system robustness.

In some embodiments, the plurality of sensors are configured to detect environmental changes across multiple signal modalities and transmit data to the processor for analysis.

In some embodiments, the processor is configured to process the data to identify patterns, generate alerts, and optimize system performance in real time.

In some embodiments, the sensing system further includes one or more physical cables operatively coupling the plurality of sensors to form an interconnected sensing network.

In some embodiments, the plurality of sensors is additionally or alternatively coupled wirelessly, while maintaining synchronized data communication across all sensing modules.

In some embodiments, the processor is configured to assign different weights to different sensor outputs based on at least one of application scenarios, user preferences, environmental context, or system design constraints.

In some embodiments, the plurality of sensors comprises a two-dimensional array of heat-sensitive elements arranged across a plane to provide spatial thermal coverage.

In some embodiments, each heat-sensitive element in the two-dimensional array is individually addressable and configured to generate spatial heat distribution data corresponding to a monitored area.

In some embodiments, the processor is configured to analyze the spatial heat distribution data to determine the presence, location, and spread pattern of a heat source or fire event.

In some embodiments, the sensing system further includes a plurality of two-dimensional arrays of heat-sensitive elements stacked in multiple layers to form a three-dimensional sensor configuration with volumetric coverage.

In some embodiments, the processor is further configured to generate a three-dimensional thermal map based on data received from the stacked two-dimensional arrays.

In some embodiments, the thermal map provides volumetric heat distribution and is used to determine fire propagation across different spatial elevations within a monitored environment.

In some embodiments, the processor is further configured to predict the potential spread of the fire based on historical spatial propagation patterns and real-time sensor data.

In another aspect, a sensing system is provided, including: a plurality of heterogeneous sensors configured to detect environmental parameters; a processor operatively coupled to the plurality of sensors; and an artificial intelligence (AI) module configured to receive data from the plurality of sensors and apply at least one machine learning algorithm to process the data for event detection or prediction.

In some embodiments, the AI module is configured to classify sensor events based on learned patterns from historical sensor data and contextual conditions.

In some embodiments, the AI module applies a neural network to correlate signals from different sensor types and generate a composite risk assessment output.

In some embodiments, the AI module is configured to dynamically select among different machine learning algorithms based on contextual parameters or performance metrics.

In some embodiments, the AI module includes at least one of: a support vector machine (SVM), decision tree, random forest, deep neural network (DNN), or ensemble learning model.

In some embodiments, the AI module is configured to update its prediction model using real-time sensor feedback through an online learning process to maintain adaptive accuracy.

In some embodiments, the sensing system further includes a user interface configured to display prediction results, risk scores, or alert levels generated by the AI module.

In another aspect, a multi-parameter fire detector is provided, including: a plurality of sensors continuously configured a long a cable; a processor configured to process signals from the plurality of sensors and couple the signals to obtain a response function; wherein the plurality of sensors comprises at least two types of sensors.

Other aspects and variations may become apparent in view of the following detailed descriptions and the drawings.

### BRIEF DESCRIPTION OF THE DRAWINGS

FIG. 1 illustrates a distributed multi-parameter linear fire detector fire detector with heterogeneous sensors, including VOC, gas, smoke, and infrared sensors, connected to composite air-tube cable, with multiple inlets and a capped outlet, an air tube, and electrical wires.

FIG. 2 illustrates a distributed multi-parameter linear fire detector fire detector with heterogeneous sensors connected to a composite cable featuring a smooth air tube without inlets, a capped outlet, electrical wires, and central air intake pores on each sensor unit.

FIG. 3 illustrates cross-sectional views of multiple implementations of a distributed multi-parameter linear fire detector, according to various embodiments.

FIG. 4 illustrates a functional block diagram of the signal processing unit, showing the internal components and the external interface.

FIG. 5 illustrates a distributed multi-parameter linear fire detector diagram, showing components such as a signal processing unit, cable with air tube, insulated wires, and various sensing modules, according to one embodiment.

FIG. 6 illustrates a diagram illustrating a a distributed multi-parameter linear fire detector with three-dimensional mapping capability for detecting and locating fire sources in space.

FIG. 7 illustrates exemplary implementations of a distributed multi-parameter linear fire detector configured for deployment in transportation environments, in accordance with various embodiments.

FIG. 8 illustrates exemplary likelihood distributions for volatile organic compound (VOC), carbon monoxide (CO), temperature, and particulate sensors under fire and normal conditions. Fire detection is performed based on a weighted joint likelihood computation across multiple sensor inputs, enabling sensor fusion for enhanced detection accuracy.

FIG. 9 Illustrates a diagram of fire classifications and an associated multi-sensor weighted signal analysis method.

FIG. 10 illustrates a Bayesian inference process for calculating fire probability using sensor data, including VOC, CO, smoke, and temperature inputs to adjust alarm levels.

FIG. 11 illustrates a machine learning-based fire detection framework using supervised, unsupervised, and time-series modeling techniques for early fire warning and alarm classification.

FIG. 12 illustrates a hybrid fire detection method combining rule-based and machine learning techniques, configured to address data scarcity and computational constraints through multi-sensor integration and anomaly detection mechanisms.

FIG. 13 illustrates a networked a distributed multi-parameter linear fire detector and its monitoring system. A distributed multi-parameter linear fire detector is deployed to transmit detection signals to a signal processing unit. This network interfaces with a plurality of display terminals and a remote mobile terminal via cloud communication.

### DETAILED DESCRIPTION

Various embodiments of the disclosure relate to fire detectors incorporating multiple types of sensors for monitoring environmental parameters associated with combustion. These sensors may be deployed individually or in combination as part of a distributed or linear configuration. By integrating diverse sensing mechanisms, such fire detectors can identify early-stage fire anomalies, enhance spatial coverage, and improve detection accuracy across a broad range of conditions.

Temperature sensing can be a component of many fire detectors and may be achieved through either contact-based or non-contact-based sensor technologies. Contact temperature sensors measure temperature via direct physical interaction with the monitored object or medium. These sensors may include resistance temperature detectors (RTDs), thermistors, thermocouples, and bimetallic elements. RTDs can use the change in resistance of metals, such as platinum, to measure temperature. They may provide high accuracy (e.g., ±0.1° C.), good stability, and signal integrity over long distances, although they may be limited by cost and a typical operating range of −200° C. to 850° C.

Thermistors may use the temperature sensitivity of semiconductor materials to generate electrical signals for monitoring purposes. These sensors can offer strong sensitivity but typically operate within a narrower temperature range (e.g., −50° C. to 300° C.) and may require linearization for accurate output. Thermocouples, formed from two dissimilar metals, can generate thermoelectric voltage based on the Seebeck effect. They may support a wide range of operation (−270° C. to 2800° C.), exhibit rapid response, and be low cost, though they may degrade over time and require cold junction compensation.

Bimetallic sensors may consist of two bonded metals with differing thermal expansion coefficients. When heated, the mechanical deformation of the metal stack can trigger a switching mechanism. These devices may be passive, low-cost, and simple but offer limited precision and repeatability, and are typically used for discrete thermal control rather than continuous measurement.

Non-contact temperature sensors operate by detecting emitted thermal energy without physical contact. These may include infrared temperature sensors, photon detectors, fiber optic sensors, and total radiation pyrometers. Infrared temperature sensors convert thermal radiation into electrical signals and may be used in shortwave to longwave infrared bands. These sensors can offer fast response times and wide operating ranges (−30° C. to 3000° C.), making them suitable for dynamic, high-temperature, or hazardous environments. They may, however, require surface emissivity calibration and are susceptible to ambient interference.

Photon detectors can generate output signals based on photon-material interactions. These sensors may be used for high-speed applications and specialized optical measurements. Fiber optic temperature sensors transmit light signals and detect temperature through changes in wavelength, intensity, or phase. They are immune to electromagnetic interference, lightweight, and intrinsically safe for use in explosive atmospheres, but their implementation may require high-quality optical connections and may be limited to −100° C. to 600° C.

Total radiation pyrometers estimate temperature by measuring total radiative output across the electromagnetic spectrum, applying the Stefan-Boltzmann law. These may be suitable for high-temperature, non-contact measurements (up to 2000° C. or more) but tend to have lower accuracy (±2%-5%), are affected by environmental interference, and cannot accurately measure low temperatures.

Linear heat sensors may include distributed sensing elements arranged along a cable and configured to detect abnormal temperature conditions over extended areas. They may rely on thermally sensitive polymers, resistive elements, or fiber optic principles. Such sensors are typically used in tunnels, cable trays, or other infrastructure requiring linear thermal surveillance.

Smoke sensing can be another mechanism for fire detection. Several types of smoke sensors may be used to detect particulate matter generated by combustion. A photoelectric scattering-type sensor may use an infrared light-emitting diode and a photodetector arranged at an angle. In the absence of smoke, the detector receives no direct light; when smoke enters the chamber, light is scattered and detected, triggering an alarm. These sensors may be particularly sensitive to small particles from smoldering fires and are cost-effective and resilient against ambient visible light.

An optical beam smoke detector aligns the emitter and photodetector directly across a monitored space. When smoke obstructs the beam, the reduction in light intensity can trigger an alarm. These sensors may be effective for detecting large-particle smoke produced by rapid combustion but may be large in size and sensitive to interference from ambient light.

Laser-based smoke sensors may use coherent light to detect very small particles, providing higher sensitivity than conventional photoelectric sensors. These may be particularly suited for cleanrooms, data centers, or high-value environments where early fire warnings can be beneficial. However, they may be more costly and complex to deploy.

Ionization smoke sensors may include a sealed reference chamber and a detection chamber open to ambient air. Ionizing radiation, typically from Americium-241, can maintain a stable ion current in clean air. When smoke particles enter the detection chamber, they may absorb ions and reduce the current, which triggers an alarm. These sensors can be highly sensitive to small particles from flaming combustion and may be compact and low-cost. However, they may be less effective at detecting large-particle smoke from smoldering fires and raise regulatory and safety considerations due to the use of radioactive material.

Volatile organic compound (VOC) sensors are designed to detect carbon-based gases emitted during thermal decomposition. These may operate using photoionization detection (PID), metal-oxide-semiconductor (MOS) sensors, or similar technologies. VOC sensors can identify decomposition products such as aldehydes, ketones, carboxylic acids, and furan derivatives before the onset of visible smoke or heat. They may be useful in early fire detection within environments prone to low-temperature degradation, such as wood-processing or food production.

Combustible gas sensors may be used to detect the presence of flammable gases including methane, propane, hydrogen, and other hydrocarbons. Detection technologies may include catalytic bead elements, thermal conductivity, or infrared absorption. These sensors can enable early warning in environments with gas accumulation risks, such as industrial plants or storage facilities.

Carbon monoxide (CO) sensors may be configured to detect CO, a toxic gas produced during incomplete combustion. Electrochemical cells, MOS technology, or infrared-based methods may be used to monitor CO levels. These sensors can be beneficial for detecting smoldering or oxygen-limited fires and may be integrated with fire detectors in enclosed or poorly ventilated areas.

In some embodiments, combinations of the above-described sensors may be deployed along a linear cable or within modular sensing modules to form a distributed multi-parameter fire detector. The sensors may be connected to a central processor configured to apply algorithms such as sensor fusion, weighted signal analysis, or rule-based evaluation to correlate multiple sensor inputs. This processing can enable early-stage fire anomaly detection, minimize false positives, and allow precise localization of fire hazards.

Certain implementations may incorporate artificial intelligence (AI) modules for signal interpretation, including use of machine learning models for classification, prediction, and continuous adaptation. Wireless communication modules and visual interfaces may also be included to provide users with alerts, temperature maps, or diagnostic data in real time. Such detectors may be suitable for use in residential, industrial, and safety-critical environments requiring high sensitivity, robust fault tolerance, and accurate spatial awareness.

A composite air-tube cable, as utilized in linear fire detectors, is a specialized cable structure designed to integrate air sampling and multi-parameter sensing capabilities along its length. This cable typically consists of a hollow air tube at its center, which facilitates the continuous sampling of air from the environment through strategically placed air inlets along the cable. Run along with the air tube are electrical conducting elements, such as power bus lines and data transmission wires, In addition, a separate pair of electrical conducting elements insulated with heat-sensitive materials. These materials change their properties in response to temperature variations, enabling the detection of heat changes indicative of fire. These electrical conducting cables can either run in parallel with eh air tube, or in a coaxial manner.

By integrating temperature sensors, smoke sensors, gas sensors, VOC sensors, and CO sensors, using the composite air-tube cable allows for comprehensive monitoring of environmental conditions. A fire detector can achieve multi-dimensional monitoring of thermal, chemical, and particulate parameters associated with combustion. This comprehensive sensing framework supports proactive fire prevention, enhanced response time, and greater reliability in detecting fires across a range of application scenarios.

Fire detection technologies and systems have undergone advancements to enhance early and accurate fire detection while reducing the incidence of false alarms. Current fire detectors, despite advancements, face limitations that hinder their effectiveness in certain environments. They suffer from slow response times, unreliable detection, and frequent false alarms. These issues are caused by single-sensor, binary alarm designs that simply switch between on and off without providing granular data. As a result, these systems struggle to deliver accurate early warnings for emerging fire risks, such as lithium-ion battery fires, which are increasingly common and highly destructive with no effective suppression method. Recent fires have led to catastrophic asset damage, environmental harm, and significant threats to safety.

Conventional fire detectors predominantly utilized point-type detectors and linear type detectors, which assessed data from each detector independently. Spot-type smoke detectors are widely used but respond slowly since smoke must travel to ceiling-mounted sensors. They cannot detect black smoke, a major limitation as many electrical fires produce it. They are also prone to false alarms from dust, steam, or insects. Aspiration air sampling detectors analyze air actively and detect smoke faster but trigger even more false alarms due to high sensitivity. Originally designed for clean environments like hospital labs, they are now used in dusty industrial settings due to a lack of alternatives.

Heat detectors also have different types such as spot and linear heat detectors, which cause fewer false alarms but respond even slower since air temperature must rise significantly before activation. Linear heat detectors are used for long distances (e.g., tunnels, cable trays, conveyors) but detect fires slowly, suffer false alarms from wire damage, and cannot pinpoint the alarm location along their thousands of feet of coverage, making targeted fire mitigation difficult.

These conventional systems typically activated alarms when a parameter surpassed predefined thresholds; however, they were constrained in sensitivity and scope, concentrating mainly on single parameter detection. This methodology frequently resulted in false alarms, missed detections, and delayed responses.

A distributed multi-parameter linear fire detector, such as the disclosed system, may integrate advanced technologies to address these limitations. For example, the system may utilize a multi-parameter linear fire detection approach to enable comprehensive real-time monitoring of fire parameters. The system may incorporate a variety of sensors, including infrared sensors, smoke sensors, volatile organic compound (VOC) sensors, combustible gas sensors, and linear heat sensors.

These sensors can be connected in series and interfaced with a signal processing unit that mitigates false positives and identifies the precise location of a fire. Additionally, the system may incorporate linear heat sensors to provide continuous monitoring of heat changes along the length of the detection cable. Additionally, the system may incorporate an air sampling function, employing an air tube with multiple inlets along the cable to continuously collect air samples for real-time analysis. This approach may provide extensive coverage and timely intervention by monitoring early fire indicators, thereby enhancing fire safety and mitigating the risk of damage in industrial environments.

Another significant limitation is the inability of conventional systems to provide comprehensive coverage. Conventional fire detectors, such as point-type smoke detectors and linear heat detectors, often operate on a singular parameter threshold alarm method. This approach lacks a holistic consideration of the on-site fire environment, leading to false alarms, missed detections, and delayed responses.

For instance, in battery energy storage facilities, early detection is crucial due to the rapid propagation of fires. However, conventional systems struggle to detect the early stages of thermal runaway and the specific gases released by battery cells before a full-blown fire occurs, delaying critical response times and increasing the risk of extensive damage and safety hazards.

Moreover, the effectiveness of fire detectors is often compromised by their reliance on singular detection methods. Systems that focus solely on heat detection or smoke detection may not be sensitive enough to detect fires at their incipient stages. For example, infrared sensors used in some systems are designed to detect heat sources at specific temperature ranges, but they may not effectively differentiate between fire-induced heat and other heat sources, such as solar radiation or ambient temperature fluctuations. This can result in missed detections or false positives, particularly in outdoor environments where such variables are prevalent.

Additionally, the rapid response required by fire detectors often leads to a trade-off between speed and accuracy. Systems designed for fast detection are more likely to be “fooled” by non-fire events, as the faster the response time, the higher the likelihood of false alarms. This dilemma presents a significant challenge for designers of fire detection and suppression systems, as they must balance the need for quick response with the risk of false alarms and unnecessary deployment of fire suppressant chemicals.

While modern fire detection technologies have made strides in improving accuracy and reliability, they still face limitations in terms of false alarms, comprehensive coverage, and early detection capabilities. These challenges highlight the need for continued innovation and the development of multi-parameter detection systems that can provide a more accurate and holistic assessment of fire hazards in various environments.

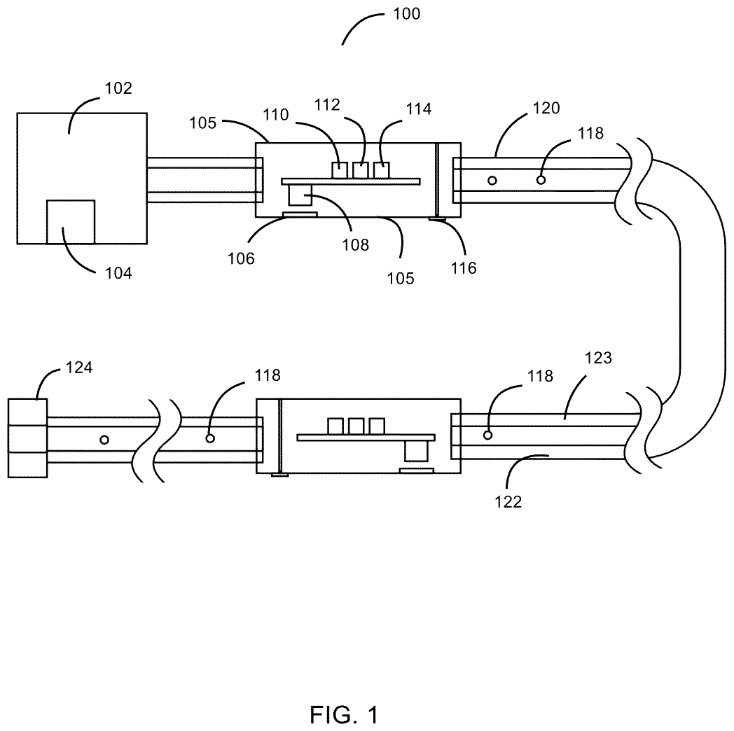

FIG. 1 illustrates an embodiment of a distributed multi-parameter linear fire detector comprising various interconnected components configured to enhance fire detection capabilities in industrial environments. The system may include a signal processing unit 102, a fan 104 for air intake, a sensing module unit 105, an infrared sensor filter 106, an infrared sensor 108, a combustible gas sensor 110, a smoke sensor 112, a volatile organic compound (VOC) sensor 114, a filter layer 116, multiple air inlets 118, and a composite air-tube cable 120, within which linear heat sensors are deployed, a power and data transmission bus 122, and an end cap 124.

The signal processing unit 102 can be configured to analyze data received from the various sensors within the system. It processes signals to determine the presence and severity of fire-related events, employing advanced algorithms to minimize false positives. This unit may improve the system's capability to provide accurate and reliable fire detection, ensuring timely alerts and interventions.

The fan 104 is positioned to draw in air from the surrounding environment, facilitating the continuous sampling of air through the system. This component can ensure that the sensors receive a steady flow of air for detecting changes in environmental conditions that may indicate the presence of fire.

The sensing module 105 houses multiple sensors, such as the infrared sensor 108, combustible gas sensor 110, smoke sensor 112, and VOC sensor 114. These sensors are configured to detect various fire indicators, such as heat, gas emissions, smoke, and volatile organic compounds. The integration of these sensors allows for a comprehensive assessment of potential fire hazards.

The infrared sensor filter 106 is positioned in front of the infrared sensor 108 to enhance the accuracy of heat detection by filtering out unwanted wavelengths. This filter can ensure that the infrared sensor accurately detects temperature variations, which may be advantageous for identifying early-stage fires.

The combustible gas sensor 110 is configured to detect the presence of flammable gases in the environment. This sensor can play a significant role in identifying potential fire hazards before they escalate, particularly in environments where combustible gases are present.

The smoke sensor 112 is designed to detect smoke particles in the air, providing an additional layer of detection capability. Smoke detection can be a significant indicator of fire, and the inclusion of this sensor may enhance the system's capability to identify fires at an early stage.

The VOC sensor 114 can be configured to detect volatile organic compounds, which may serve as early indicators of fire, particularly in industrial settings where chemical reactions may occur. This sensor may contribute to the system's multi-parameter detection approach, potentially enhancing overall sensitivity and accuracy.

The filter layer 116 can be positioned to remove impurities from the air before it reaches the sensors. The interfering substances may include dust, pollen, moisture, and other impurities that could affect the accuracy and reliability of the sensor readings. This layer may help ensure that the sensors receive clean air samples, reducing the likelihood of false alarms caused by dust or other particulates.

The air inlets 118 can be distributed along the composite air-tube cable 120, allowing for continuous air sampling along the length of the cable. This design may provide comprehensive coverage of the monitored area, enhancing the system's capability to detect fires under various conditions along the cable.

The composite air-tube cable 120 can be a component of the system, providing both air sampling capabilities and heat detection. The cable may be equipped with insulated electrical conducting wires for power and data transmission, facilitating reliable communication between the sensing modules and the signal processing unit.

The power and data transmission bus 122 can facilitate the transmission of power and data between the various components of the system. This bus may help ensure that all sensors and modules are adequately powered and that data is efficiently communicated to the signal processing unit for analysis. The linear heat sensor 123 provides continuous heat monitoring. It provides heat data to the sensing modules.

The end cap 124 can be fitted at the end of the composite air-tube cable, featuring a pore in its center to allow for the release of air and other substances. This design may help the system effectively manage airflow and maintain optimal sensor performance.

The described fire detector may integrate multiple sensing technologies to provide a robust and reliable solution for early fire detection in high-risk industrial environments. The system's capability to detect a range of fire indicators, combined with its advanced signal processing capabilities, may provide comprehensive coverage and timely intervention, and potentially reduce the risk of extensive damage and enhancing safety.

In some embodiments, a distributed multi-parameter linear fire detector is designed to sample air along its length. This system utilizes an aspiration mechanism within the signal processing unit to draw air continuously from the air tube. The air is sampled at various intervals along the cable through inlets, ensuring comprehensive coverage of the monitored area. The sampled air is then passed through filters to remove debris before being analyzed by sensors for fire detection.

To draw the airflow through inlets to sample air, a fan is configured to draw the airflow, a fan is configured to create a pressure differential that pulls air through the system efficiently. Aside from using fans, several alternative mechanisms and devices can be employed:

Membrane Pumps can be deployed to draw a steady airflow by using a flexible membrane that moves back and forth to push air through a system. Membrane pumps are advantageous due to their ability to handle a variety of gases and their relatively quiet operation, making them suitable for environments where noise is a concern. This setup can be part of a system that uses ion mobility spectrometry for detecting gases specific to the burning material. The aspiration unit in such a system could include a filtering unit, a valve, and a sample gas tube through which the gas flow is pumped. This method allows for the collection and analysis of gases from the ambient air, which can indicate the early stages of a fire.

Rotary Vane Piston Pumps use rotating vanes to move air through a chamber. They are efficient and capable of generating a consistent airflow, which can be useful for maintaining a continuous sampling of air in fire detectors.

Linear Compressors compress air in a linear motion, providing a steady and controlled airflow. They are particularly useful in systems where precise control of airflow is necessary, such as in environments with variable air pressure conditions.

Blowers can be used to create a high-volume airflow, which is beneficial for systems requiring rapid air sampling over large areas. They are often used in conjunction with other components to ensure that air samples are effectively drawn into the detector.

Aspiration Systems utilize a network of pipes or flexible tubes with aspirating holes to draw air from various locations. The air is then analyzed for fire indicators. This method allows for sampling from multiple points, providing comprehensive coverage of the monitored area.

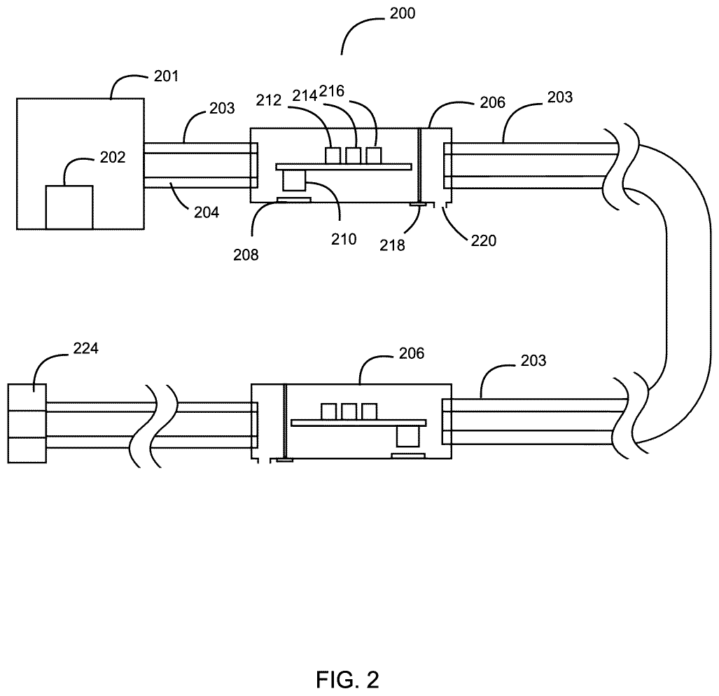

FIG. 2 illustrates a fire detector that can include an sensing module connected to a composite air-tube cable, terminating in an end cap with a central pore. This detector may enhance fire detection capabilities by incorporating multiple sensors and advanced signal processing techniques. The sensing module 206 may include a volatile organic compounds (VOC) sensor 216, a combustible gas sensor 212, a smoke sensor 214, and an infrared sensor 210. These sensors can be arranged on a circuit board within the sensing element, facilitating comprehensive monitoring of fire-related parameters.

The signal processing unit 201 is configured to receive and analyze data from the sensing module 206. It processes signals from the various sensors to ascertain the presence, type, and severity of a fire. The unit can employ advanced algorithms to reduce false positives and ensure reliable detection. Additionally, the signal processing unit may integrate data from the sensors to enhance the accuracy, reliability, specificity, and sensitivity of the fire detector.

The fan 202 is positioned to draw air into the system, supporting the air sampling mechanism. This component typically ensures continuous air sample intake through the air tube for real-time analysis. The air sampling mechanism can be advantageous for detecting early-stage fire indicators such as gas emissions and smoke, providing timely warnings of potential fire hazards.

The linear heat sensor 203 can be configured to monitor temperature variations along its length. It may include a pair of electrically conducting wires insulated with heat-sensitive material. The term heat-sensitive material refers to material that changes its properties as the temperature changes, which can be used to detect heat changes present in a fire. Examples of heat-sensitive materials include, but are not limited to, NTC (Negative Temperature Coefficient) material, PTC (Positive Temperature Coefficient) material, and heat radiation-sensitive material. The use of linear heat sensors among the sensing modules is intended to achieve full heat detection coverage of the protected area and/or object.

The cable can be connected to the sensing module 206 at one end and may be fitted with an end cap 224 at the other, which can include a central pore to facilitate airflow.

The power and data transmission bus 204 is configured to supply power to the sensing modules and facilitate data transmission between the sensors and the signal processing unit 201. This configuration ensures system operation and efficient data communication for analysis and response.

The infrared sensor filter 208 is positioned on the casing surface of sensing module, facing the detection element of the infrared sensor 210. This filter can enhance the accuracy of the infrared sensor by allowing only specific wavelengths of infrared radiation to reach the sensor, thereby improving its capability to detect fire-related heat signatures.

The filter layer 218 is positioned near the air inlet on the casing of the sensing module. It serves to remove interfering substances such as dust and moisture from the air samples before they reach the sensor components, ensuring that the data collected by the sensors is accurate and reliable, thereby reducing the likelihood of false alarms.

The cable connector 220 facilitates the connection of the composite air-tube cable 203 to the sensing module 206. This connection is important for ensuring that the data collected by the sensors is transmitted to the signal processing unit for analysis.

The end cap 224, fitted with a central pore, is designed to allow air to flow through the composite air-tube cable 203. This design ensures continuous air sample intake through the system for real-time analysis, enhancing the system's capability to detect early-stage fire indicators.

The primary distinction between the designs illustrated in FIG. 1 and FIG. 2 lies in the positioning of the air inlets. In FIG. 1, the air inlets are placed on the cable, which may optimize the sampling variety by allowing air to be drawn from more flexible locations. Conversely, FIG. 2 features air inlets located on the integrated sensing modules, which can enhance the efficiency of air intake directly at the sensing points. This variation in air inlet placement may simplify maintenance and improve the accuracy of data collection by reducing the distance air travels before reaching the sensors. Additionally, the design in FIG. 2 may offer better protection for the inlets, reducing the risk of blockages or damage.

The typical cable design for a linear fire detector with an embedded air tube involves a flexible cable structure that integrates multiple functional components to enable comprehensive fire detection. This cable can include a central hollow air tube designed for air sampling, which is flanked by a plurality of conductive wires for signal transmission and power supply, and linear heat sensor, distributed in parallel on each side. The air tube continuously draws air samples through multiple inlets distributed along the cable. This allows for real-time analysis of air samples to detect early indicators of fire, such as gas emissions and smoke.

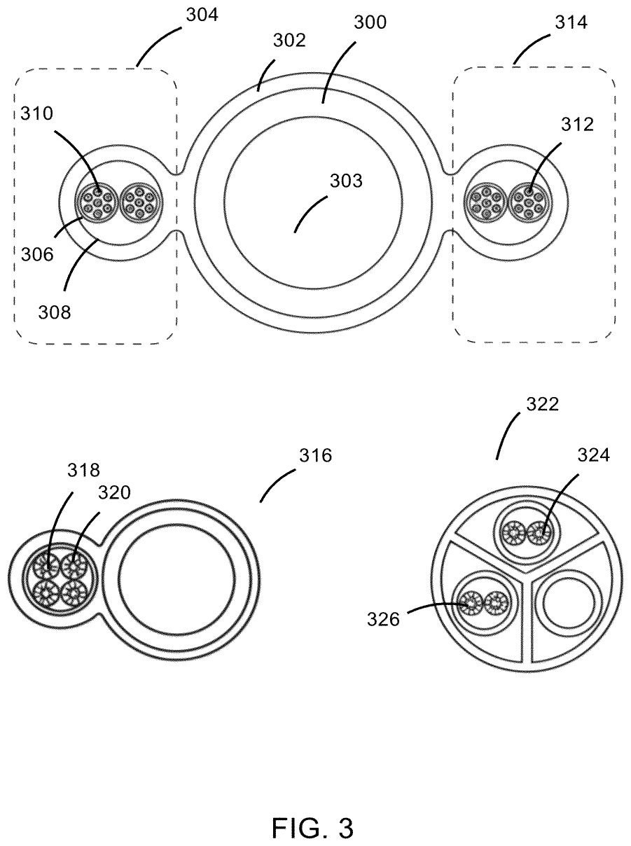

FIG. 3 illustrates cross-sectional views of multiple implementations of a distributed multi-parameter linear fire detector, according to various embodiments. The linear fire detector may include an air tube 300, which can be centrally positioned and surrounded by a protective outer sheath 302. The air tube 300 is configured to facilitate an airflow path 303, enabling continuous air sampling along its length. This configuration can allow for the detection of early fire indicators by drawing air samples through multiple inlets distributed along the cable.

The power and signal bus may employ metal conductors with an insulating sheath. These may optionally be wrapped with aluminum foil over the insulating sheath. The linear heat sensor may utilize metal conductors with an insulating sheath made of a heat-sensitive material. It can also be wrapped with aluminum foil over the insulating sheath. This configuration forms a structure with a hollow center and parallel cables on both sides, providing both structural integrity and functional capability. The entire assembly may be externally wrapped with a protective outer sheath to provide durability and protection against environmental factors.

On one side of the air tube 300, a power and data transmission bus 304 can be positioned, which may include metal conductors 310 encased in an insulating sheath 306. The data transmission bus 304 is configured to transmit power and data between the sensing modules and the signal processing unit. An aluminum foil layer 308 may optionally be applied over the insulating sheath 306, providing additional protection and potentially enhancing the integrity of the data transmission.

The opposite side of the air tube 300 can house a linear heat sensor 314. Conductors 312 can be insulated with a heat-sensitive material, allowing the linear heat sensor to monitor temperature variations continuously. This configuration can enable the system to detect heat and other parameter changes indicative of a fire event, contributing to the comprehensive monitoring capabilities of the fire detector.

The size of these conduits may vary depending on the specific requirements of the system and the components used. Factors such as data transmission rates and power consumption needs can influence the dimensions and specifications of these conduits. To enhance protection and potentially improve the integrity of data transmission, an aluminum foil layer 308 may optionally be applied over the insulating sheath 306.

The data bus, the linear heat sensor, and the power supply cord can be separated, as their conductors may differ in size and material composition.

The protective outer sheath 302 may encase the entire structure, providing durability and protection against environmental factors. This sheath can ensure the integrity of the components within, allowing the system to function effectively in various industrial environments. The sheath also aids in maintaining the structural integrity of the cable, ensuring reliable operation over extended periods. The air drawn can be sent to the sensing module, which may integrate multiple sensing modules along the cable, each optionally equipped with sensors including VOC, combustible gas, smoke, and infrared sensors.

The cross-section of another composite air tube assembly 316, according to an embodiment, incorporates a conduit cluster assembly that integrates the air tube, data transmission bus 320, linear heat sensor 318, and electrical power cable into a single cohesive structure. The larger circular assembly 322 with partitioned compartments can further enhance the modularity and scalability of the system. These compartments may house additional data transmission buses 324 and linear heat sensors 326, enabling the system to accommodate varying lengths and configurations based on specific application requirements.

A conventional fire detector may include NTC (Negative Temperature Coefficient) material-based heat connectional fire detectors, which operate by utilizing the temperature-dependent resistance properties of NTC materials. As the temperature increases, the resistance of the NTC material decreases, allowing the system to detect heat changes along the length of the detector. These detectors can be implemented as fire detection cables to provide continuous monitoring of temperature changes over large areas.

NTC-based fire detectors have notable limitations. One limitation is their inability to provide addressable detection. NTC-based fire detectors cannot pinpoint the exact location along the cable where the heat anomaly occurred. Additionally, the risk of fire detector cable damage is higher in moving environments, such as vehicles or machinery, where vibrations and mechanical stress are common. If the cable is physically cut or damaged, the entire NTC based linear detection system may become non-functional, as the electrical continuity required for operation is disrupted, potentially leading to undetected fire incidents.

The disclosed configuration addresses these limitations of conventional NTC based fire detectors. Each sensing module can be equipped with an air tube for continuous air sampling, two and more advanced sensors, and data bus interfaces to enable communication and data transfer between components. The address of each module can be uniquely assigned to instantly identify the exact location of any fire or potential fire hazard within the monitored area. Even if the cable is damaged, the fire detector may still function in partial capacity, as the detector does not require a completed circuit like the NTC-based fire detector. Moreover, configurations with enhanced robustness and flexibility can be implemented according to some embodiments. Redundant or distributed signal processing units and power supply can be added to both ends or in the middle of the system to ensure partial functionality even if part of the cable is damaged. An alert will be generated to notify the monitoring system of any detected anomalies or malfunctions. This ensures that maintenance can be promptly scheduled.

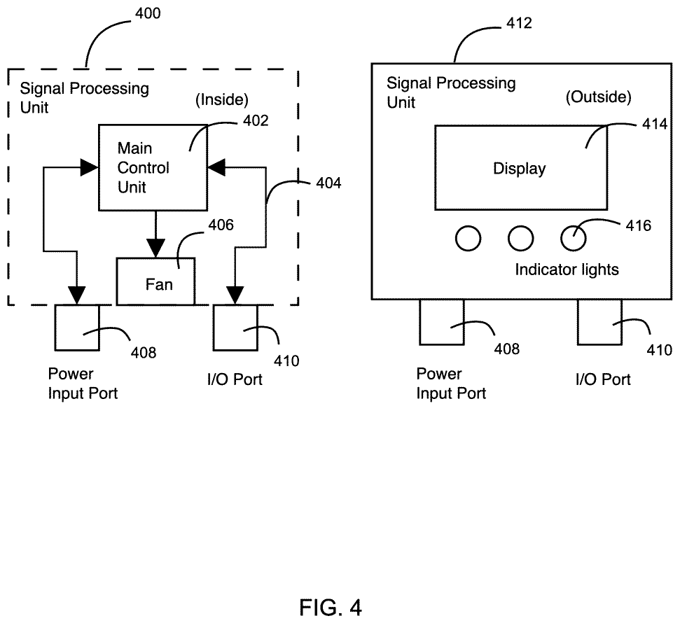

FIG. 4 illustrates a functional block diagram of the signal processing unit, showing internal components and the external interface. The internal diagram of the Signal Processing Unit 400 depicts the high-level operation of a linear multi-parameter fire detector system. It comprises several components, including the Main Control Unit 402, which can orchestrate the processing of signals received from various sensors distributed along the cable. Signal paths 404 facilitate the transmission of data between the sensors and the Main Control Unit, ensuring that relevant information is processed promptly.

The Main Control Unit 402 can be configured to execute algorithms that analyze data from multiple sensor types, including infrared, smoke, VOC, and combustible gas sensors. This unit integrates the data to improve the accuracy, reliability, and sensitivity of the fire detection process. By employing signal processing techniques, the Main Control Unit can reduce false positives and provide an assessment of fire conditions, thereby enhancing the efficacy of the detector.

Signal paths 404 are part of the communication infrastructure within the signal processing unit. These paths can handle high-speed transmission of data from the sensors to the Main Control Unit. The design of these paths ensures minimal latency and high fidelity in data transmission, which can be beneficial for real-time fire detection and response. The signal paths also support the integration of data from multiple sensors, allowing for a comprehensive analysis of environmental conditions.

The fan 406 is a component that draws airflow through the system, facilitating the air sampling function of the fire detector. By maintaining a consistent airflow, the fan can ensure that air samples are continuously drawn from the environment and delivered to the sensors for analysis. This continuous sampling capability may improve the detection of early indicators of fire, such as changes in gas concentration or smoke density, enabling timely intervention and reducing the risk of extensive damage.

The Power Input Port 408 provides electrical power to the signal processing unit and its components. This port can accommodate various power sources, ensuring that the system remains operational in diverse environments. The design of the Power Input Port ensures reliable power delivery, which can enhance the continuous operation of the fire detector.

The I/O Port 410 serves as the interface between the signal processing unit and external devices. This port enables the system to connect with terminal operating devices for functions such as setting detection alarm thresholds, data copying, transmission, and display modes. The I/O Port facilitates integration with other systems, enhancing the versatility and adaptability of the fire detector in different application scenarios.

The sensing system comprises a plurality of heterogeneous sensors configured to detect environmental parameters. These sensors are positioned along the detection cable to provide coverage of the monitored area. The system's processor is operatively coupled to the sensors, enabling it to receive and process data for event detection or prediction.

The external view of the Signal Processing Unit 412 showcases user interface components, including the Display 414 and Indicator Lights 416. The display provides real-time feedback on the status of the fire detector, including sensor readings and alarm conditions. The indicator lights offer visual cues for system status, such as power on, alarm activation, or fault conditions, allowing for monitoring by operators.

The AI module within the sensing system (not shown in FIG. 4) can be configured to classify sensor events based on learned patterns from historical sensor data. This module may apply machine learning algorithms to analyze the data, identifying patterns that can indicate the presence of a fire. By leveraging historical data, the AI module can improve its predictive accuracy over time, adapting to changes in the environment and enhancing the system's overall reliability.

The AI module may apply a neural network to correlate signals from different sensor types and generate a composite risk assessment output. This approach allows the system to integrate data from multiple sensors, providing a view of the monitored environment. The neural network can identify relationships between different sensor readings, enabling the system to detect indicators of fire that may not be identified by conventional detection methods.

The distributed multi-parameter linear fire detector offers potential advantages over conventional fire detection technologies. By integrating multiple sensors and processing capabilities, the system can provide early detection of fire hazards, location tracking, and reduced false alarms. These features make it suitable for industrial environments, where timely and accurate fire detection can enhance safety and operational continuity.

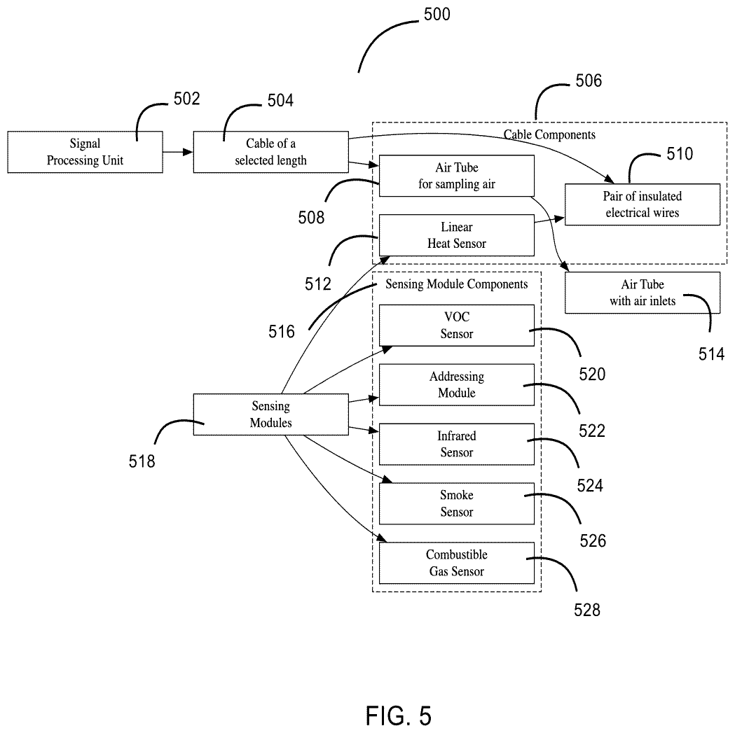

FIG. 5 illustrates a distributed multi-parameter linear fire detector diagram, showing components such as a signal processing unit, cable with air tube, insulated wires, and various sensing modules, according to one embodiment. The diagram 500 provides an overview of the system's architecture, highlighting the integration of multiple sensors and components to enhance fire detection capabilities.

The Signal Processing Unit 502 can be a central component of the system, configured to process information from the sensing modules to determine the location, type, and intensity of a fire. This unit may employ algorithms to analyze data from various sensors, potentially reducing false positives and improving detection accuracy. The signal processing unit is operatively coupled to the sensors and can be responsible for integrating data to enhance the system's response function.

The Cable 504 of a selected length may be an element of the system, incorporating an air tube for sampling air and insulated electrical conducting wires for power and data transmission. The cable is configured to facilitate continuous monitoring of environmental conditions along its length, providing comprehensive coverage of the protected area. The cable components 506 may include the air tube 508, which is configured to draw air samples for real-time analysis, and a pair of insulated electrical wires 510 for efficient power and data transmission.

The Linear Heat Sensor 512 can be integrated within the cable and may be configured to monitor heat continuously. This sensor can be employed for detecting temperature variations that may indicate the presence of a fire. The linear heat sensor may comprise a pair of electrical conducting wires insulated with heat-sensitive material, enabling it to detect changes in temperature effectively.

The Air Tube with air inlets 514 may be a feature of the system, allowing for continuous air sampling along the cable's length. The air inlets can be positioned to draw air samples from various points, facilitating the detection of early fire indicators including components such as smoke and gas emissions. This real-time air sampling function can enhance the system's ability to provide timely alerts and interventions. Each section of the linear fire detection cable may be identified by a unique address to pinpoint hazard location, which can distinguish it from conventional air sampling smoke detectors. The disclosed fire detector can be configured to localize and address hazards, and analyze air samples at each sensing module.

The Sensing Module Components 516 may include a variety of sensors, each optionally configured to detect specific fire-related parameters. The sensing modules 518 can be positioned along the cable and may include components such as a VOC Sensor 520, an Addressing Module 522, an Infrared Sensor 524, a Smoke Sensor 526, a Combustible Gas Sensor 528, a Carbon Oxygen (CO) sensor, and others. Each sensor can be configured to monitor different aspects of the environment, optionally providing a broader view of fire conditions.

The VOC Sensor 520 may be configured to detect volatile organic compounds, which can serve as early indicators of fire. This sensor can assist in identifying the presence of hazardous gases that may be released during the initial stages of a fire.

The Addressing Module 522 can be integrated into each sensing module, enabling precise location identification of potential fire hazards. This feature may allow for accurate pinpointing of fire locations, potentially enhancing response times and reducing potential damage.

The Infrared Sensor 524 may be configured to detect infrared radiation, which can indicate the presence of a heat source or fire. This sensor can assist in identifying temperature anomalies that may signal a fire event.

The Smoke Sensor 526 may be configured to detect smoke particles in the air, providing an early warning of fire. This sensor can assist in identifying the presence of combustion products, which are often early signs of a fire.

The Combustible Gas Sensor 528 may be configured to detect flammable gases that can be present in the environment. This sensor can assist in identifying gas leaks or emissions that may lead to a fire.

The system's detection algorithms may consider multiple parameters, such as temperature, gas concentration, and smoke density, to provide a comprehensive assessment of fire conditions. This multi-parameter approach can ensure that the system is capable of accurately detecting and responding to fire hazards, potentially reducing the risk of false alarms and missed detections.

In some embodiments, the distributed multi-parameter linear fire detector may be extended into a two-dimensional (2D) sensing configuration. Rather than utilizing a single linear array, the system may incorporate a planar array comprising a plurality of sensing modules arranged in both longitudinal and lateral directions to form a matrix across a surface area.

Each sensing module within the two-dimensional array may be individually addressable, enabling the system to capture and monitor localized variations in fire-related parameters such as heat, smoke, gas, Volatile Organic Compounds (VOC), and flame intensity across the monitored plane. The two-dimensional configuration may facilitate the detection of fire events with enhanced spatial resolution, allowing for the identification of both the presence and the distribution of fire anomalies, including their associated parameters, across a defined area.

The processor may be configured to aggregate data from the multiple vertically aligned distributed multi-parameter linear fire detector arrays and generate a three-dimensional map representing multiple fire related parameters throughout the monitored volume. This 3D spatial mapping capability may allow for the detection and localization of fire anomalies not only across horizontal planes but also through vertical structures. The system is particularly suited for complex environments, such as multi-story buildings, high ceiling industrial facilities, storage racks, or layered infrastructure. It enables comprehensive large area monitoring, early fire detection, and improved rapid, and targeted fire response.

In some embodiments, the linear fire detector may be extended into a two-dimensional (2D) sensing configuration. Rather than utilizing a single linear array of heat-sensitive elements, the system may incorporate a planar array comprising a plurality of heat-sensitive elements arranged in both longitudinal and lateral directions to form a matrix across a surface area.

Each heat-sensitive element within the two-dimensional array may be individually addressable, enabling the system to capture and monitor localized temperature variations across the monitored plane. The two-dimensional configuration may facilitate the detection of heat events with enhanced spatial resolution, allowing for the identification of both the presence and the distribution of thermal anomalies across a defined area.

This 2D sensing arrangement may be applicable to environments where heat or fire can propagate in multiple directions, including open industrial floors, warehouses, tunnels, or enclosed compartments. The spatial granularity provided by the two-dimensional array may support accurate fire localization, zone-based alarm triggering, and refined thermal mapping within the protected environment.

In further embodiments, the sensing system may be extended into a three-dimensional (3D) configuration by stacking multiple two-dimensional arrays of heat-sensitive elements in a vertical arrangement. Each 2D array may correspond to a different spatial elevation or floor level within the monitored environment. The stacked configuration may enable volumetric heat detection and spatial mapping across three axes-length, width, and height.

The processor may be configured to aggregate data from the multiple vertically aligned arrays and generate a three-dimensional thermal map representing heat distribution throughout the monitored volume. This 3D spatial mapping capability may allow for the detection and localization of thermal events not only across horizontal planes but also through vertical structures. By analyzing thermal signatures across different layers, the system may determine the presence, intensity, and propagation pattern of a fire or heat source in real time.

This 3D sensing configuration may be suited for environments such as multi-story buildings, industrial facilities with high ceilings, storage racks, or infrastructure with layered compartments. The ability to monitor fire-related parameters across multiple elevations may provide enhanced situational awareness, support early detection, and improve the effectiveness of fire suppression and evacuation strategies.

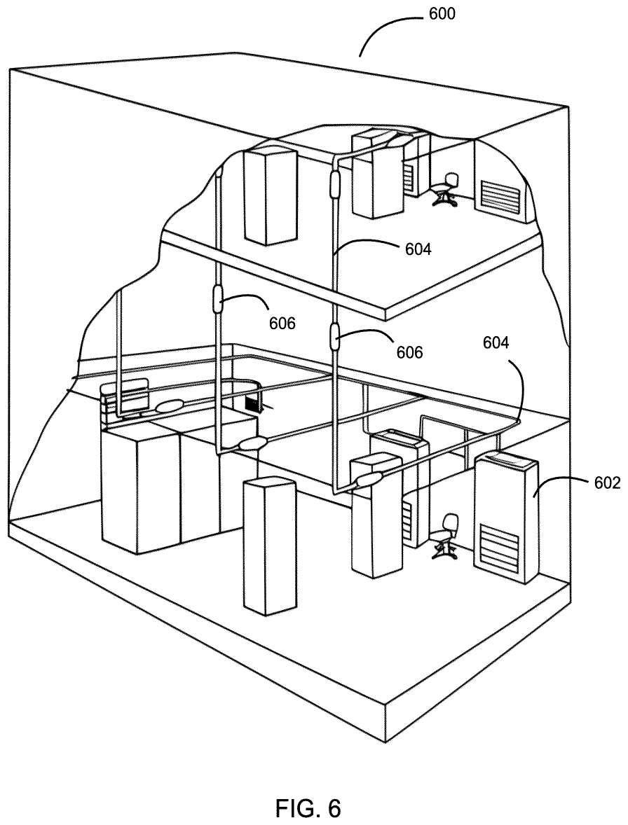

FIG. 6 illustrates an embodiment of a multi-parameter linear fire detector 600 with 3D mapping capabilities, deployed in a multi-story building. The system can employ parallel multi-parameter linear fire detectors 604, which may be consist of composite air tubes, and various sensors integrated within sensing modules 606. The sensing modules may include a variety of sensing elements such as infrared sensors, gas sensors, VOC sensors, and smoke sensors. These detectors can provide continuous temperature sensing, gas and smoke monitoring over a large area. An addressing module in each sensing module can facilitate precise location tracking of a detected fire anomaly. The signal processing unit (not illustrated in the figure) can analyze this data using advanced algorithms.

The 3D array setup may facilitate enhanced data collection and analysis. With sensors distributed throughout a volume rather than along a single line, the system can gather more comprehensive fire-related data. This data may be processed using advanced algorithms to identify patterns and anomalies that can indicate the presence of a fire. The data processing capabilities can allow for accurate and reliable fire detection, contributing to overall safety and potential risk reduction in high-risk environments.

Compared to conventional linear heat detectors or air sampling smoke detectors, the 3D configuration of the distributed multi-parameter linear fire detector may offer various advantages. These may include precise fire anomaly location identification, continuous coverage over a large volume, and multiple parameter analysis to predict fire behavior and early fire risk, while potentially reducing unwanted false alarms.

In some other embodiments, the detector can be 0-dimensional (OD), where multiple types of sensors are congregated together in a quasi-point or substantially single-point location. Such sensors may still be considered distributed in the sense that the multiple sensors can have their sensed data coupled in algorithms to achieve enhanced fire detection compared with conventional fire detectors. In conventional systems, even if smoke detectors, CO detectors, and explosive gas detectors are collocated on a single device, they typically function independently and are not coupled using the algorithms described in embodiments of the present disclosure.

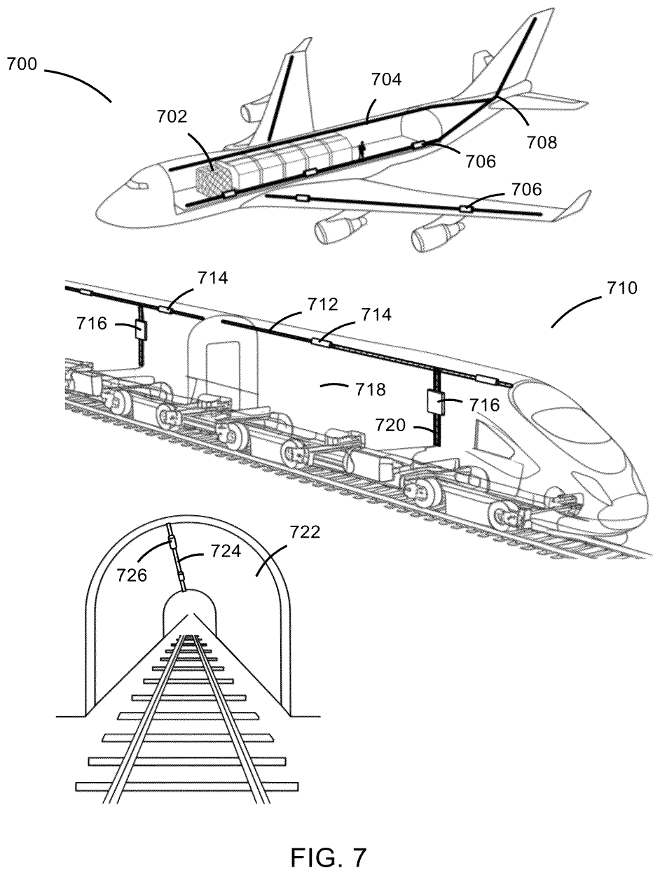

FIG. 7 illustrates exemplary implementations of a multi-sensor linear fire detector configured for deployment in transportation environments, in accordance with various embodiments. The system is depicted in three distinct contexts: an aircraft cargo compartment, a train undercarriage or passenger compartment, and a subway tunnel environment. Each deployment scenario demonstrates the system's adaptability in monitoring fire-related parameters across infrastructure zones.

The aircraft cargo compartment monitoring system, as shown in FIG. 7, includes a composite air tube 704 mounted along the ceiling or sidewall of the cargo compartment 702. The composite air tube 704 is configured to integrate with multiple sensing modules 706. These modules are positioned to provide coverage of the cargo compartment. A control unit or processing hub 708 is operatively coupled to the sensor cable 704, enabling data collection, analysis, and alarm generation. In the train fire monitoring system, the composite air tube 712, which integrates sensing modules 714, can be mounted along the structural frame of the train undercarriage or cargo compartment 718. The signal processing and control unit 716 can be mounted to the wall of the train or integrated into the control panel for easy access and monitoring. The subway tunnel environment, as depicted in diagram 722, may employ a network of multi-parameter linear fire detector cables 724 mounted on the ceiling of the tunnel. Sensor modules 726 can be positioned along the cable.

The composite air tube 704, 712, and 724 in all three implementations may provide long distance continuous fire anomaly detection. The integration of multi-sensor modules 706, 714, and 726 can support monitoring of fire-related parameters, fire anomaly location identification. while the control units 708, 716, and 728 may facilitate data analysis and alarm management. The system's scalability and adaptability can make it suitable for deployment in a range of transportation environments, addressing the fire safety challenges associated with each application.

The potential applications of this distributed multi-parameter linear fire detector may extend beyond transportation environments. It can be deployed in industrial facilities, data centers, warehouses, and residential buildings and other areas requiring distributed fire monitoring. The detector's ability to detect early-stage fire indicators, such as VOC emissions and temperature anomalies, may provide functional advantages over conventional fire detectors. By enabling timely interventions and reducing false alarms, the system can improve overall safety and operational efficiency. The detector's ability to continuously monitor fire related parameters anywhere along its length provides no blind spot protection, making it suitable for applications with long distances, large areas, and hard to reach places.

FIG. 7 illustrates the versatility of the distributed multi-parameter linear fire detector in addressing fire safety challenges across various transportation and infrastructure environments. The system's linear design, combining sensing technologies with analytics, supports coverage, early detection, and performance in high-risk scenarios.

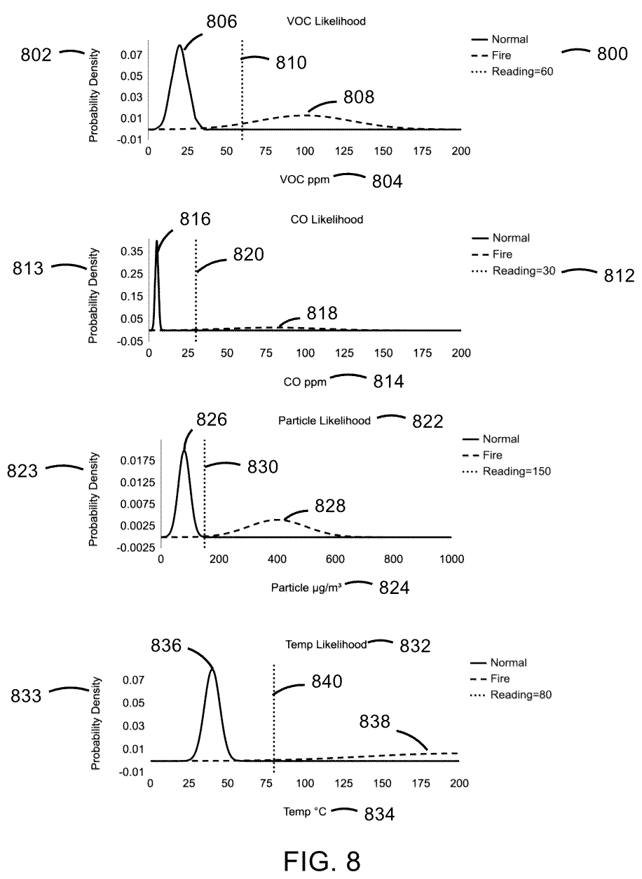

FIG. 8 illustrates likelihood distributions for various sensors, including VOC, CO, temperature, and particle sensors, under both fire and normal conditions. This figure illustrates a statistical approach that may be employed by the system to enhance fire detection accuracy through multi-sensor fusion, including a Bayesian inference model based on fire probability. Each sensor's measured value can be represented alongside its corresponding likelihood curve, which may indicate statistical deviation from a baseline condition. The VOC likelihood graph 800, for instance, shows how the VOC probability density 802 can vary along the VOC ppm axis 804, with distinct lines for normal 806 and fire conditions 808. A specific VOC reading, such as 60 ppm, is indicated by line 810, illustrating how sensor readings may be interpreted within the system.

The CO likelihood graph 812 depicts the CO probability density 813 along the CO ppm axis 814. The graph can distinguish between normal 816 and fire conditions 818, with a CO reading of 30 ppm marked by line 820. This graphical representation may aid in understanding how CO sensor data is utilized to assess fire risk, contributing to the overall multi-sensor fusion strategy.

The particle likelihood graph 822 provides insights into particle concentration detection, with the particle probability density 823 plotted against the particle μg/m³ axis 824. The graph includes lines for normal 826 and fire conditions 828, with a particle reading of 150 μg/m³ indicated by line 830. This data may be useful for detecting combustion-related particles, improving the system's ability to identify fire events.

The temperature likelihood graph 832 can depict the temperature probability density 833 along the temperature° C. axis 834. The graph may differentiate between normal 836 and fire conditions 838, with a temperature reading of 80° C. optionally marked by line 840. This temperature data may contribute to the system's capability to detect thermal anomalies that can be indicative of fire, supporting a multi-parameter detection approach.

In certain embodiments, the system utilizes a probabilistic inference model to determine the likelihood of a fire event based on a set of sensor readings. The posterior probability of a fire, conditioned on sensor data, may be computed using Bayesian inference, as shown below:

$$P ( Fire \vert Sensors ) = [ P ( Sensors \vert Fire ) \cdot P ( Fire ) ] / P ( Sensors )$$

Where:
P(Fire|Sensors) denotes the posterior probability of a fire given the observed sensor readings;
P(Sensors|Fire) represents the likelihood of observing the sensor values under fire conditions;
P(Fire) is the prior probability of a fire occurring;
P(Sensors) is a normalizing constant, which can be omitted in relative comparisons.

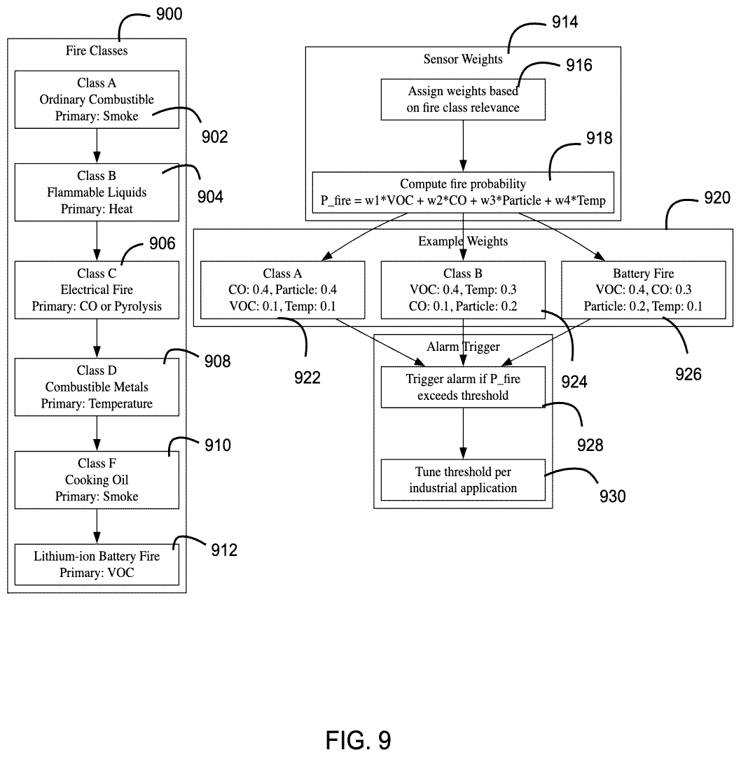

FIG. 9 illustrates a diagram of fire classifications and an associated multi-sensor weighted signal analysis method. The diagram includes various fire classes, each with distinct burning characteristics, and highlights the primary sensor types used for detection. The labeled components include fire classes 900, Class A: Ordinary Combustible 902, Class B: Flammable Liquids 904, Class C: Electrical Fire 906, Class D: Combustible Metals 908, Class F: Cooking Oil 910, Lithium-ion Battery Fire 912, Sensor Weights module 914, Assign weights based on fire class relevance 916, Compute fire probability 918, Example Weights 920, Class A Weights 922, Class B Weights 924, Battery Fire Weights 926, Trigger alarm if P (fire) exceeds threshold 928, and Tune threshold per industrial application 930. These components collectively illustrate the system's capability to adaptively detect and classify fire events based on sensor data and environmental conditions.

The fire classes 900 are categorized based on their combustion characteristics. For instance, Class A: Ordinary Combustible 902 is associated with materials such as wood and paper, which release carbon monoxide (CO) and smoke during combustion. The system can be configured to prioritize smoke sensors as the primary detection mechanism for this class, with other sensors optionally serving as secondary confirmation. This configuration may be applicable in environments such as wooden structures or forested areas.

Class B: Flammable Liquids 904 pertains to fires involving substances like oil and gasoline, which generate high temperatures rapidly with minimal CO or smoke. For this class, the system can be configured to utilize heat sensors as the primary detection mechanism. This approach may be suitable for industrial settings such as oil refineries and chemical factories, where rapid temperature escalation can indicate fire.

Class C: Electrical Fire 906 involves the combustion of materials such as plastic insulation and wiring, which produce toxic fumes, moderate smoke, and high heat. The system can be configured to prioritize CO or pyrolysis sensors for detecting these fires, as these sensors are capable of identifying the thermal decomposition of electrical components. This configuration may be relevant for power plants and data centers.

Class D: Combustible Metals 908 includes fires involving metals such as magnesium and titanium, which generate high temperatures without significant CO or smoke. The system can be configured to use temperature sensors as the primary detection mechanism for this class. This approach may be applicable in manufacturing facilities and other industrial environments where metal fires are a potential hazard.

Class F: Cooking Oil 910 pertains to fires involving cooking oils and fats, which produce thick, greasy smoke, moderate CO, and high temperatures. The system can be configured to prioritize smoke detectors for this class, making it suitable for commercial kitchens and food processing facilities.

Lithium-ion Battery Fire 912 is characterized by the release of volatile organic compounds (VOCs) such as DEC, EC, or EMC during off-gassing, which may precede thermal runaway. The system can be configured to use VOC sensors as the primary detection mechanism for this class. This configuration may be beneficial for battery energy storage facilities and electric vehicle charging stations, where early detection of off-gassing can help prevent failures.

The Sensor Weights module 914 can be configured to assign weights to each sensor based on its relevance to specific fire classes. For example, assign weights based on fire class relevance 916 ensures that sensors such as VOC for battery fires or infrared temperature for Class D fires are appropriately prioritized. This weighting system may enhance the accuracy and reliability of fire detection.

The Compute fire probability module 918 calculates a fire probability score (P_fire) by combining weighted sensor outputs. The formula P_fire=w1*VOC+w2*CO+w3*Particle+w4*Temp+other sensors can be used to integrate data from multiple sensors. Example Weights 920 demonstrate how different weights may be assigned for various fire classes. For instance, Class A Weights 922 may prioritize CO (0.4) and Particle (0.4), while Battery Fire Weights 926 may prioritize VOC (0.4) and CO (0.3).

The system can be configured to Trigger alarm if P (fire) exceeds threshold 928. This threshold may be tuned per industrial application 930 to optimize performance. For example, lower thresholds may be set for battery storage facilities due to the rapid escalation of battery fires. The system's adaptive threshold tuning may enhance its applicability across diverse environments.

The classification model distinguishes between two states: fire and normal. The likelihood function for each individual sensor is modeled using a Gaussian probability density function:

$$a . P ( x \vert State ) = ( 1 / sqrt ( 2 {πσ}^{2} ) ) \cdot exp ( - ( {( x - µ )}^{2} ) / ( 2 {σ}^{2} ) )$$

where μ represents the mean and σ denotes the standard deviation of the expected sensor response under a given state.

The joint likelihood of all sensors under each condition (fire or normal) is computed as the product of individual sensor likelihoods:

$$a . P ( Sensors \vert Fire ) = P ( VOC \vert Fire ) \cdot P ( CO \vert Fire ) \cdot P ( Smoke \vert Fire ) \cdot P ( Temp \vert Fire )$$

$$b . P ( Sensors \vert Normal ) = P ( VOC \vert Normal ) \cdot P ( CO \vert Normal ) \cdot P ( Smoke \vert Normal ) \cdot P ( Temp \vert Normal )$$

A prior probability of a fire event may be assigned based on environmental or historical factors, such as P(Fire)=0.001 and P(Normal)=0.999. These values may be dynamically updated over time based on statistical modeling, decay functions, or real-time risk adjustments in high-risk environments, e.g., aging infrastructure or volatile materials.

The final posterior probability is computed as:

$$a . P ( Fire \vert Sensors ) = \cdot [ P ( Sensors \vert Fire ) \cdot P ( Fire ) ] / \cdot [ P ( Sensors \vert Fire ) \cdot P ( Fire ) + P ( Sensors \vert Normal ) \cdot P ( Normal ) ]$$

Based on the posterior value, the system may assign confidence levels or alarm stages. For example: Pre-warning: P(Fire)>0.1, Warning: P(Fire)>0.5, Fire Alarm: P(Fire)>0.9.

Thresholds may be tunable based on application-specific sensitivity requirements. The parameters u and o may be dynamically calibrated to reflect operating environments and sensor characteristics. Adaptive tuning may occur continuously or periodically.

The classification model distinguishes between two states: fire and normal. The likelihood function for each individual sensor is modeled using a Gaussian probability density function:

$$P ( x \vert State ) = ( 1 / sqrt ( 2 {πσ}^{2} ) ) \cdot exp ( - ( {( x - µ )}^{2} ) / ( 2 {σ}^{2} ) )$$

where μ represents the mean and σ denotes the standard deviation of the expected sensor response under a given state.

The joint likelihood of all sensors under each condition (fire or normal) is computed as the product of individual sensor likelihoods:

$$P ( Sensors \vert Fire ) = P ( VOC \vert Fire ) \cdot P ( CO \vert Fire ) P ( Smoke \vert Fire ) \cdot P ( Temp \vert Fire )$$

$$P ( Sensors \vert Normal ) = P ( VOC \vert Normal ) \cdot P ( CO \vert Normal ) P ( Smoke \vert Normal ) \cdot P ( Temp \vert Normal )$$

A prior probability of a fire event may be assigned based on environmental or historical factors, such as P(Fire)=0.001 and P(Normal)=0.999. These values may be dynamically updated over time based on statistical modeling, decay functions, or real-time risk adjustments in high-risk environments, e.g., aging infrastructure or volatile materials.

The final posterior probability is computed as:

$$P ( Fire \vert Sensors ) = [ P ( Sensors \vert Fire ) \cdot P ( Fire ) ] / [ P ( Sensors \vert Fire ) \cdot P ( Fire ) + P ( Sensors \vert Normal ) \cdot P ( Normal ) ]$$

Based on the posterior value, the system may assign confidence levels or alarm stages. For example: Pre-warning: P(Fire)>0.1, Warning: P(Fire)>0.5, Fire Alarm: P(Fire)>0.9.

Thresholds may be tunable based on application-specific sensitivity requirements. The parameters u and o may be dynamically calibrated to reflect operating environments and sensor characteristics. Adaptive tuning may occur continuously or periodically.

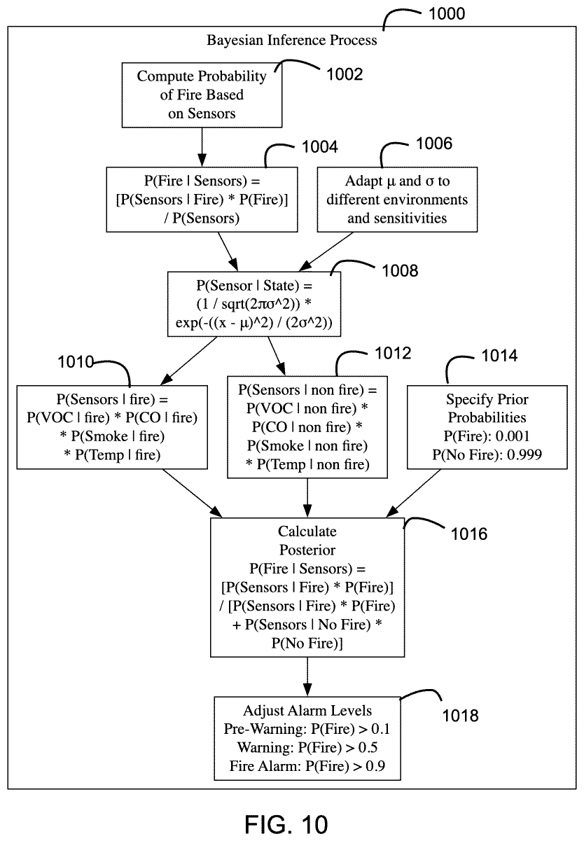

FIG. 10 illustrates a Bayesian inference process configured to calculate fire probability using sensor data, such as volatile organic compounds (VOC), carbon monoxide (CO), smoke, and temperature inputs to adjust alarm levels. The Bayesian Inference Process 1000 can compute the probability of a fire based on sensor readings, providing a probabilistic framework for fire detection. This process may integrate multiple sensor inputs to enhance the accuracy and reliability of fire detectors.

The Compute Probability of Fire Based on Sensors module 1002 is arranged to determine the likelihood of a fire event by analyzing sensor data. This involves calculating the posterior probability P(Fire|Sensors) using the formula P(Fire|Sensors)=[P(Sensors|Fire)*P(Fire)]/P(Sensors), as shown in module 1004. This calculation considers the likelihood of observing specific sensor readings given a fire, the prior probability of a fire occurring, and the overall probability of the sensor readings.

The Adapt μ and σ to different environments and sensitivities module 1006 allows the system to adjust its parameters based on environmental conditions and detection sensitivities. This adaptability may ensure that the system can maintain high accuracy across various settings by tuning the mean (μ) and standard deviation (σ) of sensor readings, as described in module 1008. This feature can enhance the system's ability to differentiate between fire and non-fire states using Gaussian distribution models.

The process further involves calculating the likelihood of sensor readings for both fire and non-fire states. Module 1010 describes the calculation of P(Sensors|fire) as the product of individual probabilities for VOC, CO, smoke, and temperature given a fire. Similarly, module 1012 outlines the calculation of P(Sensors|non-fire) for non-fire conditions. These calculations are important for accurately assessing the presence of a fire.

Prior probabilities may be specified in module 1014, where P(Fire) is set to a low value, such as 0.001, reflecting the rarity of fire events in most environments. This prior probability can be updated based on statistical data or adjusted for high-risk areas. The Calculate Posterior module 1016 uses these prior probabilities to compute the posterior probability of a fire, enabling the system to make informed decisions about fire presence.

The Adjust Alarm Levels module 1018 provides a mechanism for setting different alarm thresholds based on the computed fire probability. For instance, a pre-warning level may be triggered when P(Fire) exceeds 0.1, indicating early anomalies like slight VOC or CO rises. A warning level can be set at P(Fire)>0.5, suggesting strong evidence of a fire, while a fire alarm may be activated at P(Fire)>0.9, confirming a fire event. This multi-level alarm system allows for timely and appropriate responses to potential fire hazards.

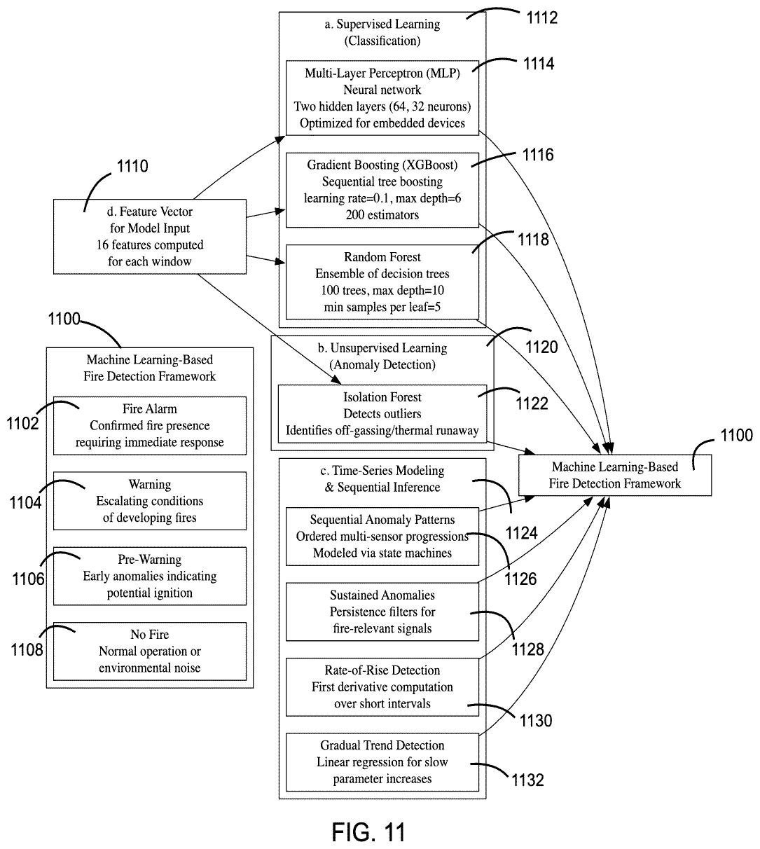

FIG. 11 illustrates a machine learning-based fire detection framework that can employ supervised, unsupervised, and time-series modeling techniques for early fire warning and alarm classification. The framework is configured to predict one of four fire stages: No Fire, Pre-Warning, Warning, and Fire Alarm. It is designed to analyze multivariate sensor data over time to classify fire risk conditions and detect early-stage anomalies.

The Machine Learning-Based Fire Detection Framework 1100 can be central to the system's operation, integrating various machine learning methodologies to enhance the detection and classification of fire events. The framework may utilize supervised learning models, such as Random Forest 1118, Gradient Boosting (XGBoost) 1116, and Multi-Layer Perceptron (MLP) Neural Network 1114, to classify input features into predefined fire states. These models are trained on labeled datasets from fire test environments, enabling classification of sensor data into one of the fire stages.

The supervised learning component 1112 of the framework is configured to process a 16-dimensional input feature vector 1110, which may include raw sensor values, temporal derivatives, and statistical descriptors. This feature vector can be advantageous for the models to perform classification. The Random Forest model 1118 is selected for its interpretability and robustness to imbalanced data, making it suitable for edge deployment. The Gradient Boosting model 1116 may provide higher accuracy and better handling of complex feature interactions, while the MLP model 1114 can be optimized for lightweight deployment on embedded devices.

In some embodiments, the framework may incorporate unsupervised learning algorithms for anomaly detection 1120.

The Isolation Forest algorithm 1122 can be a machine learning technique employed in fire detectors, optionally for early detection of lithium-ion battery fires and their precursors. This algorithm may be part of a hybrid machine learning approach that combines unsupervised anomaly detection with sensor fusion and rule-based overrides. The Isolation Forest can be effective in identifying anomalies by isolating observations in a dataset, making it suitable for detecting early signs of fire, such as off-gassing and thermal runaway, which can occur in lithium-ion batteries. This method may offer advantages because it is chemistry-agnostic and can adapt to new battery types and environmental conditions without requiring extensive retraining on new data.

Time-series modeling and sequential inference 1124 can be integral to the framework. These techniques capture the temporal dynamics of fire progression, either as engineered logic or as part of learned models. Gradual Trend Detection 1132 and Rate-of-Rise Detection 1130 are examples of time-series methods used to identify slow increases in parameters like temperature or VOC, indicative of early-stage fire conditions. Sequential Anomaly Patterns 1126 and Sustained Anomalies 1128 further enhance the system's ability to detect and confirm fire progression by analyzing ordered multi-sensor progressions observed in real fires.

The Feature Vector for Model Input 1110 is a component that feeds data into both supervised and anomaly detection models. The feature vector for model input may be configured to provide data to both supervised learning models and unsupervised anomaly detection algorithms. This vector can comprise a set of features that reflect environmental conditions relevant to fire detection, including sensor measurements and derived metrics. In some embodiments, the features may include volatile organic compounds (VOC), carbon monoxide (CO), particulate matter, and temperature, along with temporal derivatives and statistical descriptors of these measurements. This combination of raw and derived features may enable the system to assess potential fire risks and generate alerts accordingly.

The VOC feature may represent the concentration of volatile organic compounds present in the monitored environment. VOCs are often released during combustion events and may serve as an indicator of fire-related activity.

The CO feature may correspond to the concentration of carbon monoxide gas, a common byproduct of incomplete combustion. Elevated CO levels can be indicative of a fire or smoldering material.

The particulate matter feature may quantify the presence of airborne particles such as smoke. Variations in particulate concentration may support early fire detection and contribute to risk assessment.

The temperature feature may reflect the ambient thermal conditions within the detection area. Rapid or unexpected increases in temperature may signal potential fire events.

Temporal derivative features may be included to track the rate of change in sensor readings. For example, the rate of change of VOC, CO, particulate matter, and temperature over time may provide early indications of abnormal conditions associated with fire onset.

Statistical descriptors, such as the mean and variance of each sensor measurement over a defined time window, may also be included in the feature vector. Mean values may establish baseline levels for environmental parameters, while variances may highlight irregularities or fluctuations that suggest anomalous behavior.

By aggregating these features, the fire detector may enhance its ability to detect early-stage fire scenarios. The combined use of real-time sensor readings and historical statistical patterns may contribute to the robustness, accuracy, and reliability of the detection algorithm. This architecture may be particularly useful in environments where conventional single-sensor systems exhibit limitations, enabling comprehensive monitoring and timely alert generation.

Overall, the machine learning-based fire detection framework offers several advantages, such as comprehensive detection capabilities, precision and accuracy in fire characterization, reduced false alarms, and scalability across various industrial environments.

The technical considerations associated with developing reliable fire detectors may include challenges such as data scarcity in industrial environments, computational constraints at the edge, and a lack of standardized communication protocols. Additional considerations may involve ensuring system robustness across diverse conditions, integrating with existing infrastructure, and maintaining cost-effectiveness.

In some embodiments, a technical consideration in creating reliable fire detectors for industrial environments may involve limited access to high-quality, representative training data. While sensor data from residential or consumer-grade environments may be relatively accessible, such data may not accurately reflect the conditions encountered in industrial facilities, such as power plants or factories. For example, sensor systems deployed in high-voltage power cable tunnels—commonly found in heavy industrial settings—may be subject to operating conditions that may not be easily replicable or observable in standard datasets. Additionally, these environments are often restricted or hazardous, which may limit the ability to collect empirical data. Photographic documentation of a fire incident within a steel processing facility illustrates potential consequences of overheated and subsequently burned high-voltage power cables.

Another technical consideration may relate to the resource-constrained nature of edge computing devices that may be employed in industrial monitoring systems. These devices may have limited computational capacity, memory bandwidth, or power availability, which may affect their ability to execute complex machine learning (ML) models, such as those involving deep neural networks or real-time inferencing. In some scenarios, performing even lightweight model training or adaptation on such edge nodes may not be feasible, which may impede the deployment of intelligent detection algorithms locally.

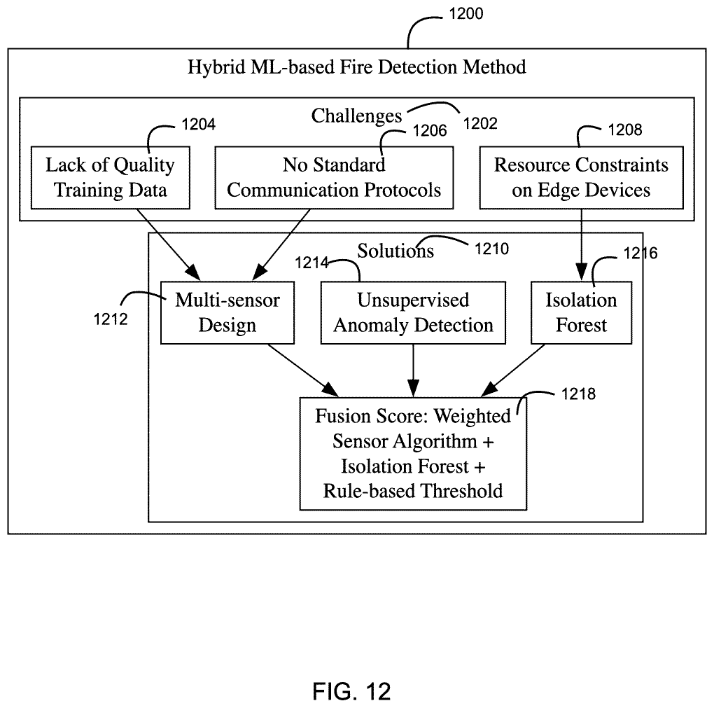

FIG. 12 illustrates a hybrid machine learning-based fire detection method, addressing challenges such as lack of data and resource constraints through solutions such as multi-sensor design and anomaly detection. The hybrid ML-based fire detection method 1200 can be configured to enhance the capabilities of conventional fire detectors by integrating advanced machine learning techniques with multi-sensor data fusion. This method can be relevant for environments where conventional fire detectors face limitations due to the absence of quality training data, as indicated by label 1204, and the lack of standard communication protocols, as shown by label 1206.

The challenges in fire detection algorithms 1202 can be addressed by the multi-sensor design 1212, which may include an edge storage and control unit. This design can monitor various environmental data and store them locally, enabling the transmission of data to a local server or cloud. This capability can be advantageous for accessing real-world data from hard-to-reach places, such as high voltage power cable tunnels in industrial settings, where data is typically scarce.

To address the resource constraints on edge devices 1208, the system may employ an unsupervised anomaly detection method 1214, specifically the Isolation Forest algorithm 1216. This approach can be chosen over more complex models such as neural network autoencoders due to its lightweight nature, making it suitable for deployment on resource-constrained edge devices. The Isolation Forest algorithm can be configured to detect anomalies in sensor data, which may indicate early signs of fire.

The fusion score 1218 can be a component of the detection method, combining a weighted sensor algorithm, Isolation Forest, and rule-based thresholds to create a comprehensive and reliable early fire detector. This fusion score can be designed to achieve high accuracy in detecting fire events while minimizing false positives.

The multi-sensor design 1212 can be configured to integrate various sensors, including VOC, combustible gas, smoke, infrared, and linear heat sensors. These sensors may work in tandem to provide a holistic view of potential fire hazards, enabling the system to detect early indicators such as gas emissions and smoke. The addressing module within each sensing module can allow for precise location tracking of detected fire anomalies, enhancing the system's accuracy and reliability.

The system's adaptability can be further enhanced by its ability to adjust detection thresholds based on environmental conditions and historical data. This feature may reduce false alarms and improve detection accuracy, making the system suitable for various industrial applications, including battery energy storage facilities, power generation plants, and data centers.

The hybrid machine learning-based fire detection method can represent an advancement in fire detection technology. By integrating advanced machine learning techniques with multi-sensor data fusion, the system can address the limitations of existing fire detectors and provide a robust solution for early fire detection in high-risk industrial applications.

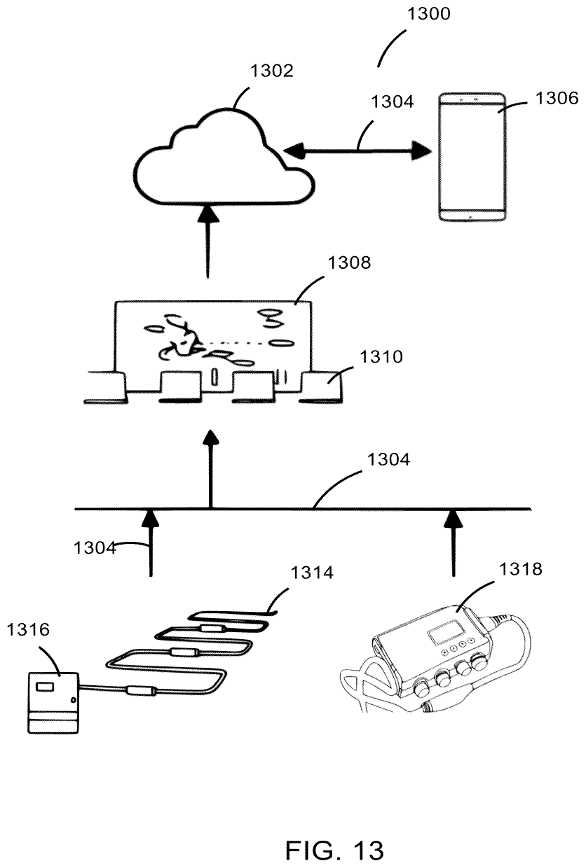

FIG. 13 illustrates a networked fire detection and monitoring system, which constitutes an embodiment of a distributed multi-parameter linear fire detector. The monitoring system may include multiple fire detectors, illustrated as the bottom layer, which can be connected to a broader signal processing and communication infrastructure. The distributed multi-parameter linear fire detector, labeled at 1314 and 1316, can be distributed throughout the environment. Other types of fire detectors, labeled 1318, may also join the network. These detectors may transmit data signals to a server 1308.

The cloud 1302 represents a cloud communication interface that facilitates data exchange between the fire detector and various external devices. This cloud-based communication may enable real-time monitoring and control of the fire detector from remote locations. The data and alarm signal path 1304 indicates potential transmission routes for data and alarm signals from the detector to the cloud and other connected devices.

The mobile device 1306 can be configured to receive alerts and data from the fire detector via the cloud 1302. This configuration may allow users to monitor fire conditions remotely and receive notifications of any detected fire events. The mobile device may also be employed to configure system settings and thresholds, providing flexibility and control over the fire detection process.

The local server 1308 may be a part of the system's infrastructure to provide data storage and processing capabilities. These servers may store historical data for analysis and reporting, as well as execute advanced algorithms for fire detection and prediction. The local servers can ensure that the system operates independently of cloud connectivity, providing redundancy and reliability.

Multiple display terminals 1310 may be connected to the system, allowing for the visualization of fire detection data and alerts for multiple locations simultaneously. These terminals may be located in control rooms or other locations within the facility, providing operators with real-time information on fire conditions and system status.

The distributed multi-parameter linear fire detector can be configured for environments such as battery energy storage facilities, power generation plants, and data centers. Its multi-parameter detection capability may allow for the early identification of fire hazards, enabling timely intervention and reducing the risk of extensive damage. The system's ability to pinpoint fire locations can enhance response times and improve overall safety.

For the convenience of description, the components of the apparatus may be divided into various modules or units according to functions, which may be separately described. Certainly, when various embodiments of the present disclosure are carried out, the functions of these modules or units can be achieved utilizing one or more equivalent units of hardware or software, as will be recognized by those having skill in the art.

The various device components, units, blocks, or portions may have modular configurations or be composed of discrete components, but nonetheless can be referred to as “modules” in general. In other words, the “components,” “modules” or “units” referred to herein may or may not be in modular forms.

Those skilled in the art should understand that the embodiments of the present disclosure can be provided for a method, system, or computer program product. Thus, various embodiments of the present disclosure can be in form of all-hardware embodiments, all-software embodiments, or a mix of hardware-software embodiments. Moreover, various embodiments of the present disclosure can be in form of a computer program product implemented on one or more computer-applicable memory media (including, but not limited to, disk memory, CD-ROM, optical disk, etc.) containing computer-applicable procedure codes therein.

Various embodiments of the present disclosure are described with reference to the flow diagrams and/or block diagrams of the methods, apparatuses, systems, and computer program product of the embodiments of the present disclosure. It should be understood that computer program instructions realize each flow and/or block in the flow diagrams and/or block diagrams as well as a combination of the flows and/or blocks in the flow diagrams and/or block diagrams. These computer program instructions can be provided to a processor of a general-purpose computer, a special-purpose computer, an embedded memory, or other programmable data processing apparatuses to generate a machine, such that the instructions executed by the processor of the computer or other programmable data processing apparatuses generate a device for performing functions specified in one or more flows of the flow diagrams and/or one or more blocks of the block diagrams.

These computer program instructions can also be stored in a computer-readable memory, such as a non-transitory computer-readable storage medium. The instructions can guide the computer or other programmable data processing apparatuses to operate in a specified manner, such that the instructions stored in the computer-readable memory generate an article of manufacture including an instruction device. The instruction device performs functions specified in one or more flows of the flow diagrams and/or one or more blocks of the block diagrams.

These computer program instructions may also be loaded on the computer or other programmable data processing apparatuses to execute a series of operations and steps on the computer or other programmable data processing apparatuses, such that the instructions executed on the computer or other programmable data processing apparatuses provide steps for performing functions specified ill one or more flows of the flow diagrams and/or one or more blocks of the block diagrams.

Implementations of the subject matter and the operations described in this disclosure can be implemented in digital electronic circuitry, or in computer software, firmware, or hardware, including the structures disclosed herein and their structural equivalents, or in combinations of one or more of them. Implementations of the subject matter described in this disclosure can be implemented as one or more computer programs, i.e., one or more modules of computer program instructions, encoded on one or more computer storage medium for execution by, or to control the operation of, data processing apparatus.

Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them.

Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, drives, or other storage devices). Accordingly, the computer storage medium may be tangible.

The operations described in this disclosure can be implemented as operations performed by a data processing apparatus on data stored on one or more computer-readable storage devices or received from other sources.

Processors suitable for the execution of a computer program such as the instructions described above include, by way of example, both general and special-purpose microprocessors, and any one or more processors of any kind of digital computer. Generally, a processor will receive instructions and data from a read-only memory, or a random-access memory, or both. Elements of a computer can include a processor configured to perform actions in accordance with instructions and one or more memory devices for storing instructions and data.

The processor or processing circuit can be implemented by one or a plurality of application specific integrated circuits (ASICs), digital signal processors (DSPs), digital signal processing devices (DSPDs), programmable logic devices (PLDs), field programmable gate arrays (FPGA), controllers, microcontrollers, microprocessors, general processors, or other electronic components, so as to perform the above image capturing method.

Implementations of the subject matter and the operations described in this disclosure can be implemented in digital electronic circuitry, or in computer software, firmware, or hardware, including the structures disclosed herein and their structural equivalents, or in combinations of one or more of them. Implementations of the subject matter described in this disclosure can be implemented as one or more computer programs, i.e., one or more portions of computer program instructions, encoded on one or more computer storage medium for execution by, or to control the operation of, data processing apparatus.

Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

In some implementations, the model can reside on local processing circuits and storage devices, and the training of the model can also be performed locally. In some implementations, the model and the training can be remotely or distributed, such as in a cloud.

Data, such as the inputs, the outputs, and model predictions, can be presented to users/operators on display screens, such as organic light-emitting diode (OLED) displays screens and liquid-crystal display (LCD) screens located on a manufacturing line and/or in a control room.

Although preferred embodiments of the present disclosure have been described, persons skilled in the art can alter and modify these embodiments once they know the fundamental inventive concept. Therefore, the attached claims should be construed to include the preferred embodiments and all the alternations and modifications that fall into the extent of the present disclosure.

The description is only used to help understanding some of the possible methods and concepts. Meanwhile, those of ordinary skill in the art can change the specific implementation manners and the application scope according to the concepts of the present disclosure. The contents of this specification therefore should not be construed as limiting the disclosure.

In the foregoing method embodiments, for the sake of simplified descriptions, the various steps are expressed as a series of action combinations. However, those of ordinary skill in the art will understand that the present disclosure is not limited by the particular sequence of steps as described herein.

According to some other embodiments of the present disclosure, some steps can be performed in other orders, or simultaneously, omitted, or added to other sequences, as appropriate.

Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

In addition, those of ordinary skill in the art will also understand that the embodiments described in the specification are just some of the embodiments, and the involved actions and portions are not all exclusively required, but will be recognized by those having skill in the art whether the functions of the various embodiments are required for a specific application thereof.

Various embodiments in this specification have been described in a progressive manner, where descriptions of some embodiments focus on the differences from other embodiments, and same or similar parts among the different embodiments are sometimes described together in only one embodiment.

It should also be noted that in the present disclosure, relational terms such as first and second, etc., are only used to distinguish one entity or operation from another entity or operation, and do not necessarily require or imply these entities having such an order or sequence. It does not necessarily require or imply that any such actual relationship or order exists between these entities or operations.

Moreover, the terms “include,” “including,” or any other variations thereof are intended to cover a non-exclusive inclusion such that a process, method, article, or apparatus that comprises a list of elements including not only those elements but also those that are not explicitly listed, or other elements that are inherent to such processes, methods, goods, or equipment.

In the case of no more limitation, the element defined by the sentence “includes a . . . ” does not exclude the existence of another identical element in the process, the method, the commodity, or the device including the element.

In the descriptions, with respect to device(s), terminal(s), etc., in some occurrences singular forms are used, and in some other occurrences plural forms are used in the descriptions of various embodiments. It should be noted, however, that the single or plural forms are not limiting but rather are for illustrative purposes. Unless it is expressly stated that a single device, or terminal, etc. is employed, or it is expressly stated that a plurality of devices, or terminals, etc. are employed, the device(s), terminal(s), etc. can be singular, or plural.

Based on various embodiments of the present disclosure, the disclosed apparatuses, devices, and methods can be implemented in other manners. For example, the abovementioned terminals devices are only of illustrative purposes, and other types of terminals and devices can employ the methods disclosed herein.

Dividing the terminal or device into different “portions,” “regions” “or “components” merely reflect various logical functions according to some embodiments, and actual implementations can have other divisions of “portions,” “regions,” or “components” realizing similar functions as described above, or without divisions. For example, multiple portions, regions, or components can be combined or can be integrated into another system. In addition, some features can be omitted, and some steps in the methods can be skipped.

Those of ordinary skill in the art will appreciate that the portions, or components, etc. in the devices provided by various embodiments described above can be configured in the one or more devices described above. They can also be located in one or multiple devices that is (are) different from the example embodiments described above or illustrated in the accompanying drawings. For example, the circuits, portions, or components, etc., in various embodiments described above can be integrated into one module or divided into several sub-modules.

The numbering of the various embodiments described above are only for the purpose of illustration, and does not represent a preference of the embodiments.

Although specific embodiments have been described above in detail, the description is merely for purposes of illustration. It should be appreciated, therefore, that many aspects described above are not intended as required or essential elements unless explicitly stated otherwise.

Various modifications of, and equivalent acts corresponding to, the disclosed aspects of the exemplary embodiments, in addition to those described above, can be made by a person of ordinary skill in the art, having the benefit of the present disclosure, without departing from the spirit and scope of the disclosure defined in the following claims, the scope of which is to be accorded the broadest interpretation to encompass such modifications and equivalent structures.

It is apparent that those of ordinary skill in the art can make various modifications and variations to the embodiments of the disclosure without departing from the spirit and scope of the disclosure. Thus, it is intended that the present disclosure cover the modifications and the modifications.

Various embodiments in this specification have been described in a progressive manner, where descriptions of some embodiments focus on the differences from other embodiments, and same or similar parts among the different embodiments are sometimes described together in only one embodiment.

In addition, in the description of the present disclosure, the terms “center,” “longitudinal,” “lateral,” “length,” “width,” “thickness,” “upper,” “lower,” “front,” “rear,” “left,” “right,” “vertical,” “horizontal,” “top,” “bottom,” “inside,” “outside,” “clockwise,” “counterclockwise,” “axial,” “radial,” “circumferential,” etc. are based on the azimuth or position relationship shown in the drawings, and are only for the convenience of describing the present disclosure and simplifying the description. The orientation and construction and operation in a specific orientation cannot be understood as a limitation on the present disclosure.

In addition, the terms “first” and “second” are used for descriptive purposes only and cannot be understood as indicating or implying relative importance or implicitly indicating the number of technical features indicated. Therefore, the features defined as “first” and “second” can explicitly or implicitly include at least one of the features. In the description of the present disclosure, the meaning of “a plurality” is at least two, for example, two, three, etc., unless it is specifically and specifically defined otherwise.

Moreover, the terms “include,” “including,” or any other variations thereof are intended to cover a non-exclusive inclusion within a process, method, article, or apparatus that comprises a list of elements including not only those elements but also those that are not explicitly listed, or other elements that are inherent to such processes, methods, goods, or equipment.

In the case of no more limitation, the element defined by the sentence “includes a . . . ” does not exclude the existence of another identical element in the process, the method, or the device including the element.

Specific examples are used herein to describe the principles and implementations of some embodiments. The description is only used to help convey understanding of the possible methods and concepts. Meanwhile, those of ordinary skill in the art can change the specific manners of implementation and application thereof without departing from the spirit of the disclosure. The contents of this specification therefore should not be construed as limiting the disclosure.

In the descriptions, with respect to circuit(s), unit(s), device(s), component(s), etc., in some occurrences singular forms are used, and in some other occurrences plural forms are used in the descriptions of various embodiments. It should be noted; however, the single or plural forms are not limiting but rather are for illustrative purposes. Unless it is expressly stated that a single unit, device, or component etc. is employed, or it is expressly stated that a plurality of units, devices or components, etc. are employed, the circuit(s), unit(s), device(s), component(s), etc. can be singular, or plural.

Based on various embodiments of the present disclosure, the disclosed apparatuses, devices, and methods can be implemented in other manners. For example, the above-mentioned devices can employ various methods of use or implementation as disclosed herein.

Dividing the device into different “regions,” “units,” or “layers,” etc. merely reflect various logical functions according to some embodiments, and actual implementations can have other divisions of “regions,” “units,” or “layers,” etc. realizing similar functions as described above, or without divisions. For example, multiple regions, units, or layers, etc. can be combined or can be integrated into another system. In addition, some features can be omitted, and some steps in the methods can be skipped.

Those of ordinary skill in the art will appreciate that the units, regions, or layers, etc. in the devices provided by various embodiments described above can be provided in the one or more devices described above. They can also be located in one or multiple devices that is (are) different from the example embodiments described above or illustrated in the accompanying drawings. For example, the units, regions, or layers, etc. in various embodiments described above can be integrated into one module or divided into several sub-modules.

The order of the various embodiments described above is only for the purpose of illustration and does not represent a preference for the embodiments.

Although specific embodiments have been described above in detail, the description is merely for purposes of illustration. It should be appreciated, therefore, that many aspects described above are not intended as required or essential elements unless explicitly stated otherwise.

In the present disclosure, the terms “installation,” “connected,” “connected,” “fixed” and other terms shall be understood in a broad sense unless otherwise specified and limited, for example, they can be fixed connections or removable connections or integrated; it can be mechanical or electrical; it can be directly connected or indirectly connected through an intermediate medium; it can be the internal connection of two elements or the interaction between two elements, unless otherwise specified. For those of ordinary skill in the art, the specific meanings of the above terms in the present disclosure can be understood according to specific situations.

In the present disclosure, unless explicitly stated and defined otherwise, the first feature being “on” or “over” the second feature may be the first and second features in direct contact, or the first and second features indirectly in contact through an intermediate medium. Moreover, the first feature being “above” the second feature may indicate that the first feature is directly above or obliquely above the second feature, or it only indicates that the first feature is higher in level than the second feature. The first feature being “below,” “under,” or “underneath” the second feature indicates that the first feature may be directly below or obliquely below the second feature, or it may simply indicate that the first feature is less horizontal than the second feature.

In the description of this specification, the description with reference to the terms “one embodiment,” “some embodiments,” “examples,” “specific examples,” or “some examples” and the like means specific features described in conjunction with the embodiments or examples. Structures, materials, or features are included in at least one embodiment or example of the disclosure. In this specification, the schematic expressions of the above terms are not necessarily directed to the same embodiment or example. Furthermore, the particular features, structures, materials, or characteristics described can be combined in any suitable manner in any one or more embodiments or examples. In addition, without any contradiction, those skilled in the art can combine and combine different embodiments or examples and features of the different embodiments or examples described in this specification.

Various modifications of, and equivalent acts corresponding to the disclosed aspects of the exemplary embodiments can be made in addition to those described above by a person of ordinary skill in the art having the benefit of the present disclosure without departing from the spirit and scope of the disclosure contemplated by this disclosure and as defined in the following claims. As such, the scope of this disclosure is to be accorded the broadest reasonable interpretation so as to encompass such modifications and equivalent structures.

What is claimed is:

1. A distributed multi-parameter linear fire detector, comprising:
a signal processing unit, a sensing module, and a composite air-tube cable;
wherein the composite air-tube cable comprises a cable of a selected length comprising an air tube, a pair of insulated electrical conducting wires for power and data transmission, and a linear heat sensor;
wherein the signal processing unit comprises a first housing, a fan, and a first circuit board;
wherein the fan and the first circuit board are disposed within the first housing, and the first housing is provided with an exhaust hole;
wherein the signal processing unit is configured to process signals from a plurality of sensors and couple the signals algorithmically to obtain a response function;
wherein the sensing module comprises a second housing, sensing elements, and a second circuit board, wherein the sensing elements and the second circuit board are disposed within the second housing, the sensing element is electrically connected to the second circuit board, and the second housing is provided with an air inlet, wherein the air inlets are located at multiple places on the air-tube;
wherein the composite air-tube cable is electrically connected to the second circuit board and communicates with the interior of the second housing, one end of the composite air-tube cable is provided with an end cap, and another end is electrically connected to the first circuit board and communicates with the interior of the first housing;
wherein from the end cap, by activating the fan, fire characteristic substances are drawn from the air inlet of the sensing module into the second housing, wherein the sensing element is in communication electrically with the first circuit board, and the sensing element is configured to collect various information about fire characteristic substances.

2. The distributed multi-parameter linear fire detector according to claim 1, wherein one sensing module includes at least two different types of sensing elements, wherein each sensing element comprises at least one of a particle sensor, a combustible gas sensor, a smoke sensor, a heat sensor, or a CO sensor.

3. The distributed multi-parameter linear fire detector according to claim 1, wherein the signal processing unit further includes an alarm device, wherein the alarm device is in signal connection with the first circuit board, and the first circuit board is configured to determine whether the fire characteristic substances collected by the sensing elements trigger an alarm.

4. The distributed multi-parameter linear fire detector according to claim 1, wherein multiple sensing modules are provided, and the second circuit boards of the multiple sensing modules are connected to the first circuit board via the composite air-tube cable.

5. The distributed multi-parameter linear fire detector according to claim 4, wherein the sensing module further includes an address code, the address code is provided on the second circuit board, and the address code is configured to obtain the location where an alarm is triggered.

6. The distributed multi-parameter linear fire detector according to claim 1, wherein the composite air-tube cable includes an air tube and a linear heat sensor, the linear heat sensor is configured to measure temperature and transmit signals to the first circuit board, and the air tube is configured for the transmission of fire characteristic substances.

7. The distributed multi-parameter linear fire detector according to claim 6, wherein the second housing further includes a detection chamber inside, the composite air-tube cable connects with the detection chamber, and the detection chamber connects with the air inlet.

8. The distributed multi-parameter linear fire detector according to claim 7, wherein both ends of the air tube connect with the detection chambers inside two adjacent second housings, or one end of the air tube is connected to the end cap and the other end connects with the detection chamber of the second housing, or one end of the air tube connects with the interior of the second housing and the other end connects with the interior of the first housing.

9. The distributed multi-parameter linear fire detector according to claim 8, wherein the second housing further includes a filter inside, the filter is located at the air inlet, and the filter is configured to filter unwanted substances from fire characteristic substances.

10. The distributed multi-parameter linear fire detector according to claim 9, wherein the signal processing unit and/or multiple sensing modules are selectively installed on the surface of the object to be measured or within the space to be measured.

11. The distributed multi-parameter linear fire detector according to claim 1, wherein the processor is configured to process the data to identify patterns, generate alerts, and optimize system performance, and is further configured to:
predict the potential spread of the fire based on historical spatial propagation patterns and real-time sensor data;
assign weights to different sensing element output based on application scenarios and user preferences to obtain an overall score of the fire anomaly; or
obtain overall probability of a fire by combining individual fire-related parameter probabilities derived from each sensing elements.

12. The distributed multi-parameter linear fire detector according to claim 1, further comprising an artificial intelligence (AI) module configured to receive data from the plurality of sensors and apply at least one machine learning algorithm to process the data for event detection or prediction.

13. The distributed multi-parameter linear fire detector according to claim 12, wherein the AI module is configured to classify sensor events based on learned patterns from historical sensor data.

14. The distributed multi-parameter linear fire detector according to claim 13, wherein the AI module applies a supervised or unsupervised model including at least one of a neural network or an isolation forest to correlate signals from different sensor types and generate a composite risk assessment output.

15. The distributed multi-parameter linear fire detector according to claim 13, wherein the AI module is configured to dynamically select among different machine learning algorithms based on contextual parameters or performance metrics.

16. The distributed multi-parameter linear fire detector according to claim 13, wherein the AI module includes at least one of:
a support vector machine (SVM), decision tree, random forest, deep neural network (DNN), or ensemble learning model.

17. The distributed multi-parameter linear fire detector according to claim 13, wherein the AI module is configured to update its prediction model using real-time sensor feedback through an online learning process.

18. The distributed multi-parameter linear fire detector according to claim 13, further comprising a user interface configured to display prediction results, risk scores, or alert levels generated by the AI module.

19. The distributed multi-parameter linear fire detector according to claim 12, wherein the processor and the AI module are configured to implement a hybrid method combining the machine learning model and rule-based decision-making to determine whether to trigger fire alarm.

20. The distributed multi-parameter linear fire detector according to claim 1, wherein the linear heat sensor comprises a pair of electrical conducting wires insulated with heat sensitive material; and wherein the plurality of sensors comprise at least one type of sensing elements continuously distributed along the cable.
